(19) United States
(12) Patent Application Publication
(10) Pub. No.: US 2024/0244668 A1
(43) Pub. Date: Jul. 18, 2024

(54) RANDOM ACCESS CHANNEL TRANSMISSION AND DOWNLINK MONITORING BY A HALF-DUPLEX USER EQUIPMENT

(71) Applicant: QUALCOMM INCORPORATED, San Diego, CA (US)

(72) Inventors: Muhammad Nazmul Islam, Littleton, MA (US); Jing Lei, San Diego, CA (US); Carsten Aagaard Pedersen, Bolton, MA (US); Murali Menon, Acton, MA (US); Chao Wei, Beijing (CN)

(21) Appl. No.: 18/574,170

(22) PCT Filed: Aug. 5, 2021
(86) PCT No.: PCT/CN2021/110917

§ 371 Date: Dec. 26, 2023

(51) Int. Cl. H04W 74/0833; H04B 7/06; H04L 5/16

(52) U.S. Cl. CPC H04W 74/0833; H04B 7/06964; H04L 5/16

(57) ABSTRACT

Methods, systems, and devices for wireless communications are described. A user equipment (UE) may monitor for one or more downlink reference signals periodically transmitted from a base station during a first time period. The UE may determine that the UE is to participate in a random access procedure with the base station during a random access occasion, while the UE is operating in a half-duplex communication mode. The UE may identify that a first downlink reference signal is scheduled during a second time period that includes at least one random access occasion that corresponds with a reference signal for which the UE is configured to monitor, where the second time period is a subset of the first time period. As such, the UE may refrain from monitoring for the downlink reference signal during the time period in favor or proceeding with the random access procedure.

### CROSS REFERENCE

The present application is a 371 national stage filing of International PCT Application No. PCT/CN2021/110917 by Islam et al. entitled “RANDOM ACCESS CHANNEL TRANSMISSION AND DOWNLINK MONITORING BY A HALF-DUPLEX USER EQUIPMENT,” filed Aug. 5, 2021, which is assigned to the assignee hereof, and which is expressly incorporated by reference in its entirety herein.

### TECHNICAL FIELD

The following relates to wireless communications, including random access channel (RACH) transmission and downlink monitoring by a half-duplex user equipment (UE).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support random access channel (RACH) transmission and downlink monitoring by a half-duplex user equipment (UE). Generally, the described techniques provide for the UE to monitor for one or more downlink reference signals periodically transmitted from a base station in a first time period. In some cases, the UE may determine that the UE is to participate in a RACH procedure with the base station during a RACH occasion. The UE may identify that a first downlink reference signal transmitted from the base station is scheduled during a second time period that includes at least one RACH occasion that corresponds with a reference signal for which the UE is configured to monitor, where the second time period is a subset of the first time period. That is, the UE may identify an overlap between the RACH occasion and the first downlink reference signal (e.g., common downlink resources). Based on the overlap, the UE may refrain from monitoring for the first downlink reference signal during at least the second time period in favor of proceeding with the RACH procedure. Additionally or alternatively, the base station may determine that the UE is participating in the RACH procedure with the base station during the RACH occasion, and as such the base station may refrain from transmitting the one or more downlink reference signals during the RACH occasion.

In some cases, the UE may identify that one or more other downlink reference signals of the one or more downlink reference signals have corresponding RACH occasions that are scheduled during the first time period but outside of the second time period. The UE may transmit a RACH for the RACH procedure outside of the second time period based on the identifying. That is, the UE may monitor for the downlink reference signal in the overlapping portion of the RACH occasion and may transmit RACH in the non-overlapping portion of the RACH occasion.

A method for wireless communications at a UE is described. The method may include monitoring for one or more downlink reference signals periodically transmitted from a base station during a first time period, determining that the UE is to participate in a RACH procedure with the base station during a RACH occasion while the UE is operating in a half-duplex communications mode, identifying that a first downlink reference signal of the one or more downlink reference signals is scheduled during a second time period that includes at least one RACH occasion that corresponds with a reference signal for which the UE is configured to monitor, where the second time period is a subset of the first time period, and refraining from monitoring for the first downlink reference signal during at least the second time period in favor of proceeding with the RACH procedure based on the identifying.

An apparatus for wireless communications at a UE is described. The apparatus may include at least one processor, memory coupled with the at least one processor, and instructions stored in the memory. The instructions may be executable by the at least one processor to cause the apparatus to monitor for one or more downlink reference signals periodically transmitted from a base station during a first time period, determine that the UE is to participate in a RACH procedure with the base station during a RACH occasion while the UE is operating in a half-duplex communications mode, identify that a first downlink reference signal of the one or more downlink reference signals is scheduled during a second time period that includes at least one RACH occasion that corresponds with a reference signal for which the UE is configured to monitor, where the second time period is a subset of the first time period, and refrain from monitoring for the first downlink reference signal during at least the second time period in favor of proceeding with the RACH procedure based on the identifying.

Another apparatus for wireless communications at a UE is described. The apparatus may include means for monitoring for one or more downlink reference signals periodically transmitted from a base station during a first time period, means for determining that the UE is to participate in a RACH procedure with the base station during a RACH occasion while the UE is operating in a half-duplex communications mode, means for identifying that a first downlink reference signal of the one or more downlink reference signals is scheduled during a second time period that includes at least one RACH occasion that corresponds with a reference signal for which the UE is configured to monitor, where the second time period is a subset of the first time period, and means for refraining from monitoring for the first downlink reference signal during at least the second time period in favor of proceeding with the RACH procedure based on the identifying.

A non-transitory computer-readable medium storing code for wireless communications at a UE is described. The code may include instructions executable by at least one processor to monitor for one or more downlink reference signals periodically transmitted from a base station during a first time period, determine that the UE is to participate in a RACH procedure with the base station during a RACH occasion while the UE is operating in a half-duplex communications mode, identify that a first downlink reference signal of the one or more downlink reference signals is scheduled during a second time period that includes at least one RACH occasion that corresponds with a reference signal for which the UE is configured to monitor, where the second time period is a subset of the first time period, and refrain from monitoring for the first downlink reference signal during at least the second time period in favor of proceeding with the RACH procedure based on the identifying.

In some examples of the method, apparatuses, and non-transitory computer-readable medium described herein, refraining from monitoring for the first downlink reference signal may include operations, features, means, or instructions for refraining from monitoring for the first downlink reference signal during the second time period in favor of proceeding with the RACH procedure, where the second time period includes the at least one RACH occasion and a switch gap before and after the at least one RACH occasion.

In some examples of the method, apparatuses, and non-transitory computer-readable medium described herein, refraining from receiving the first downlink reference signal may include operations, features, means, or instructions for refraining from monitoring for the first downlink reference signal during the second time period based on a capability of the UE that indicates a size of the switch gap before and after the at least one RACH occasion.

In some examples of the method, apparatuses, and non-transitory computer-readable medium described herein, the size of the switch gap indicated as the capability of the UE depends on whether the UE may be a dual phase locked loop UE or a single phase locked loop UE.

Some examples of the method, apparatuses, and non-transitory computer-readable medium described herein may further include operations, features, means, or instructions for delaying a radio link monitoring (RLM) procedure or a beam failure detection (BFD) procedure based on refraining from receiving the first downlink reference signal during the second time period.

In some examples of the method, apparatuses, and non-transitory computer-readable medium described herein, refraining from monitoring for the first downlink reference signal may include operations, features, means, or instructions for refraining from monitoring a serving cell of the UE, a neighboring cell of the UE, or both for one or more UE-specific control signals based on refraining from monitoring for the first downlink reference signal.

Some examples of the method, apparatuses, and non-transitory computer-readable medium described herein may further include operations, features, means, or instructions for continuing to monitor for the first downlink reference signal periodically transmitted from the base station based on a completion of the RACH procedure.

Some examples of the method, apparatuses, and non-transitory computer-readable medium described herein may further include operations, features, means, or instructions for refraining from monitoring for the first downlink reference signal during the first time period in favor of proceeding with the RACH procedure.

Some examples of the method, apparatuses, and non-transitory computer-readable medium described herein may further include operations, features, means, or instructions for identifying that one or more other downlink reference signals of the one or more downlink reference signals may have corresponding RACH occasions that may be scheduled during the first time period but outside of the second time period and transmitting, for the RACH procedure, a RACH outside of the second time period based on the identifying.

Some examples of the method, apparatuses, and non-transitory computer-readable medium described herein may further include operations, features, means, or instructions for selecting, for the RACH procedure, a second downlink reference signal of the one or more other downlink reference signals based on RACH occasion corresponding to the second downlink reference signal being scheduled during the first time period but outside of the second time period.

In some examples of the method, apparatuses, and non-transitory computer-readable medium described herein, the at least one RACH occasion corresponds to the selected second downlink reference signal.

Some examples of the method, apparatuses, and non-transitory computer-readable medium described herein may further include operations, features, means, or instructions for transmitting, to the base station, an indication that the UE initiated the RACH procedure.

In some examples of the method, apparatuses, and non-transitory computer-readable medium described herein, monitoring for the one or more downlink reference signals may include operations, features, means, or instructions for configuring the monitoring for RLM, BFD, channel condition monitoring, cross link interference (CLI), or a combination thereof.

In some examples of the method, apparatuses, and non-transitory computer-readable medium described herein, the one or more downlink reference signals include a synchronization signal block (SSB), a channel state information reference signal (CSI-RS), a tracking reference signal (TRS), a phase TRS, or a demodulation reference signal (DMRS).

In some examples of the method, apparatuses, and non-transitory computer-readable medium described herein, the RACH procedure includes four-step RACH transmissions and two-step RACH transmissions.

In some examples of the method, apparatuses, and non-transitory computer-readable medium described herein, the half-duplex communications mode in which the UE may be operating may be a half-duplex frequency division duplex communications mode.

A method for wireless communications at a base station is described. The method may include determining that a UE is participating in a RACH procedure with the base station during a RACH occasion, the UE operating in a half-duplex communications mode and refraining from transmitting one or more downlink reference signals during the RACH occasion based on the determination.

An apparatus for wireless communications at a base station is described. The apparatus may include at least one processor, memory coupled with the at least one processor, and instructions stored in the memory. The instructions may be executable by the at least one processor to cause the apparatus to determine that a UE is participating in a RACH procedure with the base station during a RACH occasion, the UE operating in a half-duplex communications mode and refrain from transmitting one or more downlink reference signals during the RACH occasion based on the determination.

Another apparatus for wireless communications at a base station is described. The apparatus may include means for determining that a UE is participating in a RACH procedure with the base station during a RACH occasion, the UE operating in a half-duplex communications mode and means for refraining from transmitting one or more downlink reference signals during the RACH occasion based on the determination.

A non-transitory computer-readable medium storing code for wireless communications at a base station is described. The code may include instructions executable by at least one processor to determine that a UE is participating in a RACH procedure with the base station during a RACH occasion, the UE operating in a half-duplex communications mode and refrain from transmitting one or more downlink reference signals during the RACH occasion based on the determination.

Some examples of the method, apparatuses, and non-transitory computer-readable medium described herein may further include operations, features, means, or instructions for receiving an indication that the UE initiated the RACH procedure and refraining from transmitting the one or more downlink reference signals during the RACH occasion based on receiving the indication.

Some examples of the method, apparatuses, and non-transitory computer-readable medium described herein may further include operations, features, means, or instructions for continuing to transmit the one or more downlink reference signals periodically based on a completion of the RACH procedure.

Some examples of the method, apparatuses, and non-transitory computer-readable medium described herein may further include operations, features, means, or instructions for continuing to transmit the one or more downlink reference signals periodically from the base station during a time period that includes at least one RACH occasion of a set of multiple RACH occasions and receiving a RACH outside of the time period.

In some examples of the method, apparatuses, and non-transitory computer-readable medium described herein, the one or more downlink reference signals include an SSB, a CSI-RS, a TRS, a phase TRS, or a DMRS.

### BRIEF DESCRIPTION OF THE DRAWINGS

FIG. 1 illustrates an example of a wireless communications system that supports random access channel (RACH) transmission and downlink monitoring by a half-duplex user equipment (UE) in accordance with aspects of the present disclosure.

FIG. 2 illustrates an example of a wireless communications system that supports RACH transmission and downlink monitoring by a half-duplex UE in accordance with aspects of the present disclosure.

FIG. 3 illustrates an example of a timeline that supports RACH transmission and downlink monitoring by a half-duplex UE in accordance with aspects of the present disclosure.

FIG. 4 illustrates an example of a process flow that supports RACH transmission and downlink monitoring by a half-duplex UE in accordance with aspects of the present disclosure.

FIGS. 5 and 6 show block diagrams of devices that support RACH transmission and downlink monitoring by a half-duplex UE in accordance with aspects of the present disclosure.

FIG. 7 shows a block diagram of a communications manager that supports RACH transmission and downlink monitoring by a half-duplex UE in accordance with aspects of the present disclosure.

FIG. 8 shows a diagram of a system including a device that supports RACH transmission and downlink monitoring by a half-duplex UE in accordance with aspects of the present disclosure.

FIGS. 9 and 10 show block diagrams of devices that support RACH transmission and downlink monitoring by a half-duplex UE in accordance with aspects of the present disclosure.

FIG. 11 shows a block diagram of a communications manager that supports RACH transmission and downlink monitoring by a half-duplex UE in accordance with aspects of the present disclosure.

FIG. 12 shows a diagram of a system including a device that supports RACH transmission and downlink monitoring by a half-UE in accordance with aspects of the present disclosure.

FIGS. 13 through 16 show flowcharts illustrating methods that support RACH transmission and downlink monitoring by a half-duplex UE in accordance with aspects of the present disclosure.

### DETAILED DESCRIPTION

In some cases, a wireless multiple-access communications system may include one or more base stations or one or more network access nodes, each simultaneously or concurrently supporting communication for multiple communication devices (e.g., user equipments (UEs)). In some examples, a communication device (e.g., a base station, a UE) may support concurrent transmission and reception as part of a full-duplex mode or full-duplex communications. For example, a UE may operate in a full-duplex mode, where the UE may transmit on an uplink and receive on a downlink simultaneously (e.g., at least partially overlapping), either on the same frequency resource or on different frequency resources. In some cases, the UE may support full-duplex frequency division duplex (FD-FDD) communications where the UE may likewise transmit on an uplink and receive on a downlink simultaneously. In some cases, for FD-FDD communications, the UE may participate in a random access channel (RACH) procedure during a RACH occasion if the RACH occasion overlaps with downlink reference signals (e.g., synchronization signal blocks (SSBs)) and common downlink resources (e.g., due to the full-duplex capabilities of the UE). For a UE operating using time division duplex (TDD), RACH occasions would generally be non-overlapping with the downlink reference signals and the common downlink resources as a result of the TDD configuration.

In contrast, in some wireless communications systems, a base station and a UE may support half-duplex communications and, as such, may communicate over an uplink channel and over a downlink channel during non-overlapping time intervals. For example, the base station and the UE may support half-duplex FDD (HD-FDD) communications, where a UE may lack the ability to transmit on an uplink and receive on a downlink simultaneously. The UE may have one phase-locked loop which the UE may switch between uplink and downlink communications.

In some cases, a base station may support FD-FDD operations while a UE may support HD-FDD operations. In such a scenario, it may be possible for downlink resources and uplink resource to overlap for the UE. In these scenarios, the UE may not be able to perform both monitoring of the downlink resources and transmission of an uplink signal at the same time: the UE is operating in half duplex mode. In a specific example, due to half-duplex constraints, a UE using HD-FDD communications may be unable to monitor for downlink reference signals and common downlink resources while also transmitting RACH. As such, a RACH transmission may impact downlink reference signal monitoring for UEs in HD-FDD communications.

As described herein, a UE operating in a half-duplex communications mode may use improved RACH transmission and downlink monitoring techniques. The UE may monitor for one or more downlink reference signals periodically transmitted from a base station in a first time period. In some cases, the UE may determine that the UE is to participate in a RACH procedure with the base station during a RACH occasion. The UE may identify that a first downlink reference signal transmitted from the base station is scheduled during a second time period that includes at least one RACH occasion that corresponds with a reference signal for which the UE is configured to monitor, where the second time period is a subset of the first time period. That is, the UE may identify an overlap between the RACH occasion and the first downlink reference signal (e.g., common downlink resources). Based on the overlap, the UE may refrain from monitoring for the first downlink reference signal during at least the second time period in favor of proceeding with the RACH procedure. Additionally or alternatively, the base station may determine that the UE is participating in the RACH procedure with the base station during the RACH occasion, and as such the base station may refrain from transmitting the one or more downlink reference signals during the RACH occasion.

In some cases, the UE may identify that the downlink reference signal is scheduled during a time period that may include at least one RACH occasion of multiple RACH occasions. For example, the UE may identify that one or more other downlink reference signals of the one or more downlink reference signals have corresponding RACH occasions that are scheduled during the first time period but outside of the second time period. The UE may transmit a RACH for the RACH procedure outside of the second time period based on the identifying. That is, the UE may monitor for the downlink reference signal in the overlapping portion of the RACH occasion and may transmit RACH in the non-overlapping portion of the RACH occasion.

Particular aspects of the subject matter described herein may be implemented to realize one or more advantages. The described techniques may support improvements in RACH transmission and downlink monitoring by a UE operating in a half-duplex communications mode. For example, in some cases, the described techniques may enable the UE to suspend monitoring of downlink reference signals in favor of transmitting RACH during a RACH occasion, which may increase efficiency and reduce collisions between uplink and downlink communications. As such, supported techniques may include improved network operations, and, in some examples, may promote network efficiencies, among other benefits.

Aspects of the disclosure are initially described in the context of wireless communications systems. Aspects of the disclosure are then described in the context of timelines and process flows. Aspects of the disclosure are further illustrated by and described with reference to apparatus diagrams, system diagrams, and flowcharts that relate to RACH transmission and downlink monitoring by a half-duplex UE.

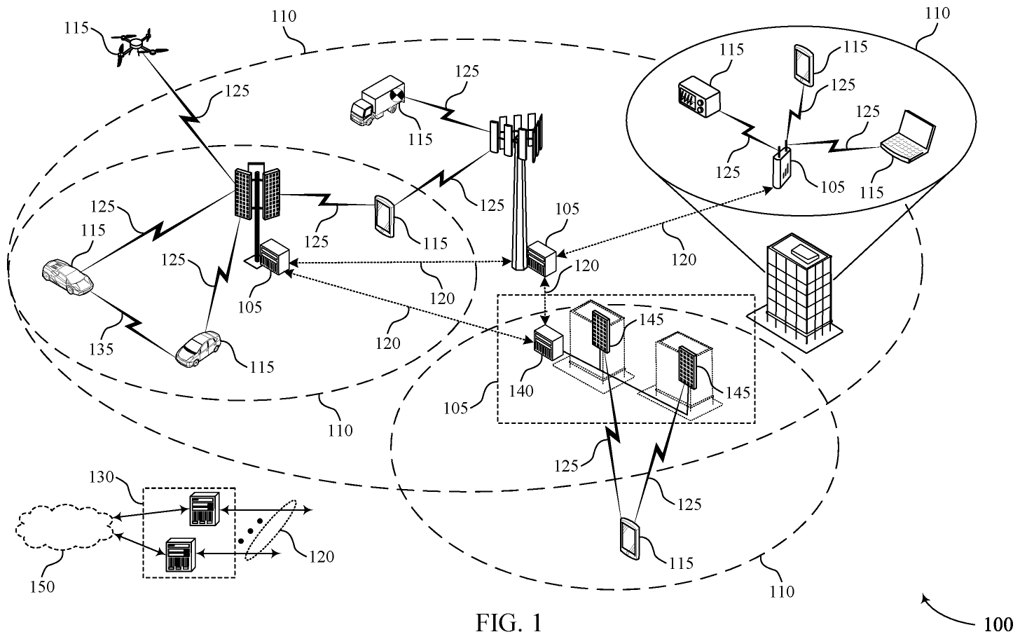

FIG. 1 illustrates an example of a wireless communications system 100 that supports RACH transmission and downlink monitoring by a half-duplex UE in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrow band IoT (NB-IOT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IOT (also referred to as CAT NB1) UEs, as well as other types of UEs. eMTC and NB-IOT may refer to future technologies that may evolve from or may be based on these technologies. For example, eMTC may include FeMTC (further eMTC), eFeMTC (enhanced further eMTC), and mMTC (massive MTC), and NB-IOT may include eNB-IOT (enhanced NB-IOT), and FeNB-IOT (further enhanced NB-IOT).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (e.g., the communication link from the AP to the device) and uplink (e.g., the communication link from the device to the AP). A wireless personal area network (PAN), which may include a Bluetooth connection, may provide for short range wireless connections between two or more paired wireless devices. For example, wireless devices such as cellular phones may utilize wireless PAN communications to exchange information such as audio signals with wireless headsets. Components within a wireless communication system may be coupled (for example, operatively, communicatively, functionally, electronically, and/or electrically) to each other.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5 GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some cases, a wireless multiple-access communications system may include one or more base stations 105 or one or more network access nodes, each simultaneously or concurrently supporting communication for multiple communication devices (e.g., UEs 115). In some examples, a communication device (e.g., a base station 105, a UE 115) may support concurrent transmission and reception as part of a full-duplex mode or full-duplex communications. For example, a UE 115 may operate in a full-duplex mode, where the UE 115 may transmit on an uplink and receive on a downlink simultaneously (e.g., at least partially overlapping), either on the same frequency resource or on different frequency resources. In some cases, the UE 115 may support FD-FDD communications where the UE 115 may likewise transmit on an uplink and receive on a downlink simultaneously. In some cases, an FD-FDD UE 115 may participate in a RACH procedure during a RACH occasion if the RACH occasion overlaps with downlink reference signals (e.g., SSBs) and common downlink resources (e.g., due to the full-duplex capabilities of the UE 115). However, for a TDD UE, RACH occasions may be non-overlapping with the downlink reference signals and the common downlink resources (e.g., downlink of tdd-ul-dl-configCommon) because the TDD UE may lack the ability to transmit on an uplink and receive on a downlink simultaneously.

In some wireless communications systems, a base station 105 and a UE 115 may support half-duplex communications and, as such, may communicate over an uplink channel and over a downlink channel during non-overlapping time intervals. For example, the base station 105 and the UE 115 may support HD-FDD communications, where a UE 115 may lack the ability to transmit on an uplink and receive on a downlink simultaneously. The UE 115 may have one phase-locked loop which the UE 115 may switch between uplink and downlink communications. In some cases, for UEs operating in an HD-FDD communications mode, RACH occasions may overlap with downlink reference signals (e.g., SSBs) and common downlink resources, which may allow a network (e.g., a base station 105) to reuse RACH occasions for UEs 115 operating in both FD-FDD and HD-FDD communication modes that may perform RACH procedures. However, due to half-duplex constraints, an HD-FDD UE 115 may be unable to monitor for the downlink reference signals and the common downlink resources while transmitting RACH. That is, the UE 115 may be unable to simultaneously receive a downlink reference signal and transmit RACH. In some cases, a RACH occasion may fail to impact downlink reference signal monitoring because RACH and downlink reference signal transmissions may be separate in the time domain. However, in the frequency domain, the UE 115 may transmit RACH or may monitor for a downlink reference in the corresponding location that may overlap with the RACH. As such, a RACH transmission may impact downlink reference signal monitoring for UEs 115 operating using HD-FDD communications.

In some examples, a UE 115 operating using HD-FDD communications may be a reduced capability (e.g., RedCap) UE. Reduced capability UEs may include smartphones (e.g., low-end smartphones, eMBB UEs), industrial wireless sensor networks (IWSNs), surveillance cameras, smart wearables (e.g., smart watches), and other relaxed IoT devices. Reduced capability UEs may also be used in URLLC communications and V2X communications. In some cases, reduced capability UEs may have lower peak throughput, latency, and reliability requirements as compared to other wireless devices, and may use low power consumption and system overhead (e.g., highly efficient), may have a limited bandwidth (e.g., 20 MHZ), and may be low cost.

In some cases, a UE 115 (e.g., a reduced capability UE) may initiate a RACH transmission based on a trigger event. For example, the UE 115 may gain initial access from an idle state (e.g., RRC_IDLE) and may transmit an early indication of the reduced capability UE type. In some examples, the UE 115 may follow an RRC connection reestablishment (e.g., if in the idle state) to transmit RACH. In some cases, the UE 115 may be in a connected state (e.g., RRC_CONNECTED), and the RACH transmission may be triggered by downlink or uplink data arrival when an uplink synchronization status is “non-synchronized.” Additionally or alternatively, the RACH transmission may be triggered based on uplink data arrival during the connected mode when physical uplink control channel (PUCCH) resources for a scheduling request may be unavailable. In some examples, the UE 115 may initiate the RACH transmission if the scheduling request fails. In some cases, the UE 115 may receive a request via RRC signaling upon synchronous reconfiguration (e.g., handover), or the UE 115 may transition from the connected state to an inactive state (e.g., RRC_INACTIVE), which may trigger the RACH transmission. In some cases, the RACH transmission may be triggered if the UE 115 receives a request for additional system information or if the UE 115 performs a beam failure recovery procedure.

In some examples, the UE 115 may initiate a physical RACH (PRACH) transmission based on a RACH occasion. For example, the UE 115 may receive validation of the RACH occasion, and may map a downlink reference signal (e.g., an SSB) to the valid RACH occasion. The UE 115 may then select a RACH occasion based on a measured synchronization signal (SS) reference signal received power (SS-RSRP), and the UE 115 may perform priority handling for the PRACH transmission. If a collision occurs (e.g., between the PRACH and a downlink reference signal), the UE 115 may re-select a RACH occasion. Following the priority handling, the UE 115 may perform the PRACH transmission.

In some cases, a base station 105 may configure different RACH occasions or SSB-to-RACH occasion mapping patterns for UEs 115 operating in a full-duplex or a half-duplex communications mode. The base station 105 may provide SSB or physical broadcast channel (PBCH) block indexes (e.g., by ssb-PositionsInBurst in SIB1 or ServingCellConfigCommon), which may be mapped to valid PRACH occasions in some order based on one or more parameters. For example, the SSB or PBCH block indexes may be mapped first in increasing order of preamble indexes within a single PRACH occasion, second, in increasing order of frequency resource indexes for frequency multiplexed PRACH occasions, third, in increasing order of time resource indexes for time multiplexed PRACH occasions within a PRACH slot, or fourth, in increasing order of indexes for PRACH slots.

For a Type-1 RACH procedure, the UE may be provided a quantity N of SSB or PBCH block indexes associated with one PRACH occasion and a quantity R or contention-based preambles per SSB or PBCH block index, per valid PRACH occasion (e.g., by ssb-perRACH-OccasionAndCB-PreamblesPerSSB). For the Type-1 RACH procedure, or for a Type-2 RACH procedure with separate configurations of PRACH occasions from the Type-1 RACH procedure, if N<1, one SSB or PBCH index may be mapped to 1/N consecutive valid PRACH occasions and R contention-based preambles with consecutive indexes associated with the SSB or PBCH block index per valid PRACH occasion starting from preamble index 0. In some cases, if N≥1, R contention-based preambles with consecutive indexes associated with SSB or PBCH block index n (e.g., where 0≤n≤N−1) per valid PRACH occasion start from preamble index n·N_preamble\hat{ }total/N may be provided (e.g., by totalNumberOfRA-Preambles for Type-1 RACH procedures, or by msgA-TotalNumberOfRA-Preambles for Type-2 RACH procedures). The R contention-based preambles may have separate configurations of PRACH occasions from a Type-1 RACH procedure, and R may be an integer multiple of N.

In some cases, SSB-to-RACH occasion mapping may be configured by a base station 105 in ssb-perRACH-Occasion AndCB-PreamblesPerSSB. In some cases, this field may include a choice which may convey information about a number of SSBs per RACH occasion. For example, a value of oneEighth in the field may correspond to one SSB associated with 8 RACH occasions, a value of oneFourth may correspond to one SSB associated with 4 RACH occasions, as so on. The field may also include enumerated values which may indicate the number of contention-based preambles per SSB. For example, a value of n4 may correspond to 4 contention-based preambles per SSB, a value of n8 may correspond to 8 contention-based preambles per SSB, and so on. The total number of codebook (CB) preambles in a RACH occasion may be given by CB-preambles-per-SSB*max(1, SSB-per-rach-occasion).

A UE 115 may validate a RACH occasion based on one or more rules. For example, in FD-FDD communications, every RACH occasion may be valid for a UE 115. For TDD communications, a RACH occasion may be valid if the RACH occasion is non-overlapping with a downlink portion of a downlink and uplink TDD pattern (e.g., provided in tdd-UL-DL-ConfigurationCommon), and if the RACH occasion fails to precede or overlap with a downlink reference signal (e.g., an SSB) in a PRACH slot. Further, for TDD communications, the RACH occasion may be valid if the RACH occasion starts at least Ngap symbols after a last downlink reference signal or a last downlink symbol, where a base station 105 may use the Ngap symbols for interference management, and where the Ngap symbols may additionally provide a switching gap for the UE 115. In some cases, for HD-FDD communications, a UE 115 may validate a RACH occasion by re-using the rule associated with FD-FDD communications for RACH occasion validation, and by handling downlink and uplink collisions separately. However, in such cases, the UE 115 may refrain from monitoring for a downlink reference signal after RACH initiation if the selected RACH occasion overlaps with the location of the downlink reference signal. In some cases, the UE 115 may reuse the rule of the TDD communications in principle, and the UE 115 may avoid a collision between the RACH occasion and a downlink reference signal based on a RACH occasion invalidation procedure. As such, the base station 105 may configure different RACH occasions or SSB-to-RACH occasion mapping patterns for UEs 115 operating in a full-duplex or a half-duplex communications mode, which may increase resource and power consumption and signaling overhead.

In some cases, a UE 115 (e.g., an HD-FDD UE) may monitor for SSBs (e.g., downlink reference signals) in different time periods. Based on a configuration for an SSB, the UE 115 may measure the SSB in some time period (e.g., T_(L1-RSRP_Measurement_Period_SSB) (ms)). For example, for a connected state, non-discontinuous reception (DRX) configuration, the UE 115 may measure the layer 1 (L1) RSRP (L1-RSRP) for an SSB within a time period of max(T_Report,ceil(M*P)*T_SSB), where T_SSB may represent the periodicity of an SSB index configured for the L1-RSRP measurement (e.g., ssb-periodicity ServingCell), T_Report may represent a configured periodicity for reporting, P=1 where P may depend on some overlap between the SSB resources and a measurement gap, and M=3, where M may represent the number of samples (e.g., a number of periods of an SS burst set) that the UE 115 may measure in one RSRP. That is, assuming M=3 and P=1, the UE 115 may monitor the L1-RSRP of the configured SSB at least once within every three samples. In some examples, for a DRX cycle≤320 ms, the UE 115 may measure the L1-RSRP for an SSB within a time period of max(T_Report, ceil(K*M*P)*max (T_(DRX,) T_SSB), where K=1 when T_SSB≤40 ms and highSpeedMeasFlag-r16 is configured and K=1.5 otherwise, and where T_DRX may represent a DRX cycle length. In some examples, for a DRX cycle>320 ms, the UE 115 may measure the L1-RSRP for an SSB within a time period of ceil(M*P)*T_DRX.

In some examples, L1-RSRP measurement periods may also be defined for both SSB and channel state information (CSI) reference signal (CSI-RS) based radio link monitoring (RLM), beam failure detection (BFD), layer 3 (L3) RSRP (L3-RSRP), L3 reference signal received quality (L3-RSRQ), L1 signal-to-interference-and-noise ratio (L1-SINR), and cross link interference (CLI). In some cases, in TDD, RACH occasions may be non-overlapping with SSB resources. In FD-FDD, a UE 115 may measure an SSB even if the UE 115 performs a RACH procedure in a connected mode. In HD-FDD however, a UE 115 may be unable to measure the SSB if a RACH occasion overlaps with SSB resources used for the SSB and if the UE 115 is performing a RACH transmission. That is, the UE 115 may refrain from monitoring for the SSB for L1-RSRP measurements when the UE 115 starts a RACH procedure during the measurement period (e.g., if the UE 115 is configured by a higher layer to transmit RACH). In some examples, the measurement periods may account for additional SSB samples based on whether the UE 115 may initiate a RACH transmission.

A UE 115 may receive physical downlink control channel (PDCCH) transmissions and physical downlink shared channel (PDSCH) transmissions, along with downlink reference signals (e.g., SSBs). In some TDD networks, a UE 115 may refrain from transmitting physical uplink shared channel (PUSCH), PUCCH, or PRACH, in SSB symbols, and as such, the UE 115 may fail to receive PDCCH, PDSCH, or CSI-RSs in valid RACH occasions (e.g., because the SSB symbols and the RACH occasion may be non-overlapping). For example, for operation on a single carrier in the unpaired spectrum, for a set of symbols of a slot indicated to a UE 115 (e.g., by ssb-PositionsInBurst in SIB1 or ssb-PositionsInBurst in ServingCellConfigCommon), and for the reception of SSBs, PBCH blocks, or both, the UE 115 may refrain from transmitting PUSCH, PUCCH, or PRACH in the slot if a transmission may overlap with any symbol from the set of symbols, and the UE 115 may refrain from transmitting a sounding reference signal (SRS) in the set of symbols of the slot. The UE 115 may refrain from expecting the set of symbols of the slot to be indicated as uplink (e.g., by tdd-UL-DL-ConfigurationCommon, or tdd-UL-DL-ConfigurationDedicated) when provided to the UE 115.

In some examples, for a set of symbols of a slot that may be indicated to the UE 115 for reception of SSBs or PBCH blocks in any multiple serving cells (e.g., by ssb-PositionsInBurst in SystemInformationBlockType1 or by ssb-PositionsInBurst in ServingCellConfigCommon), when provided to the UE 115, the UE 115 may refrain from transmitting PUSCH, PUCCH, or PRACH in the slot if a transmission may overlap with any symbol from the set of symbols. Additionally or alternatively, the UE 115 may refrain from transmitting an SRS in the set of symbols of the slot in any of the multiple serving cells. In some cases, for a set of symbols of a slot corresponding to a valid PRACH occasion and Ngap symbols before the valid PRACH occasion, the UE 115 may refrain from receiving PDCCH, PDSCH, or CSI-RSs in the slot if a reception may overlap with any symbol from the set of symbols. The UE 115 may refrain from expecting the set of symbols of the slot to be indicated as downlink (e.g., by tdd-UL-DL-ConfigurationCommon or tdd-UL-DL-ConfigurationDedicated). However, in HD-FDD networks, a UE 115 may start transmitting RACH on its own and may refrain from receiving SSBs, CSI-RSs, PDCCH, or PDSCH.

As described herein, a UE 115 operating in a half-duplex communications mode may use improved RACH transmission and downlink monitoring techniques. The UE 115 may monitor for one or more downlink reference signals periodically transmitted from a base station 105 in a first time period. In some cases, the UE 115 may determine that the UE 115 is to participate in a RACH procedure with the base station 105 during a RACH occasion. The UE 115 may identify that a first downlink reference signal transmitted from the base station 105 is scheduled during a second time period that includes at least one RACH occasion that corresponds with a reference signal for which the UE 115 is configured to monitor, where the second time period is a subset of the first time period. That is, the UE 115 may identify an overlap between the RACH occasion and the first downlink reference signal (e.g., common downlink resources). Based on the overlap, the UE 115 may refrain from monitoring for the first downlink reference signal during at least the second time period in favor of proceeding with the RACH procedure. Additionally or alternatively, the base station 105 may determine that the UE 115 is participating in the RACH procedure with the base station 105 during the RACH occasion, and as such the base station 105 may refrain from transmitting the one or more downlink reference signals during the RACH occasion.

In some cases, the UE 115 may identify that the downlink reference signal is scheduled during a time period that may include at least one RACH occasion of multiple RACH occasions. For example, the UE 115 may identify that one or more other downlink reference signals of the one or more downlink reference signals have corresponding RACH occasions that are scheduled during the first time period but outside of the second time period. The UE 115 may transmit a RACH for the RACH procedure outside of the second time period based on the identifying. That is, the UE 115 may monitor for the downlink reference signal in the overlapping portion of the RACH occasion and may transmit RACH in the non-overlapping portion of the RACH occasion.

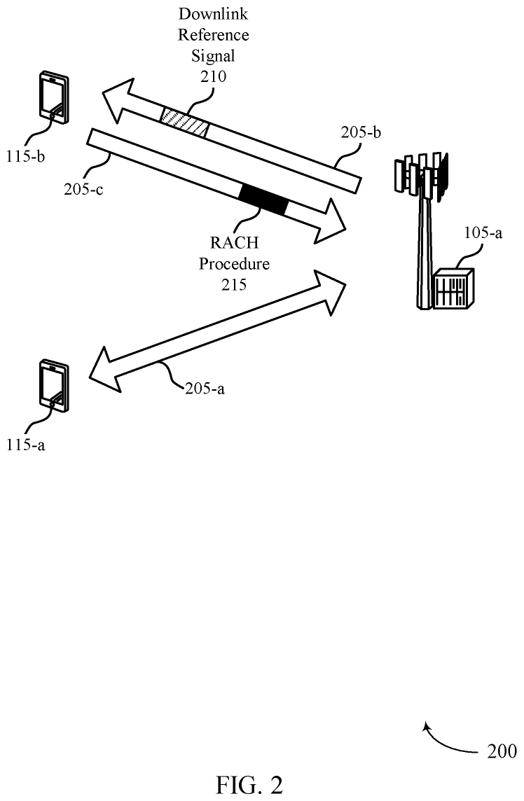

FIG. 2 illustrates an example of a wireless communications system 200 that supports RACH transmission and downlink monitoring by a half-duplex UE in accordance with aspects of the present disclosure. In some examples, the wireless communications system 200 may implement aspects of the wireless communications system 100 or may be implemented by aspects of the wireless communications system 100. For example, the wireless communications system 200 may include a UE 115-a, a UE 115-b, and a base station 105-a, which may be examples of corresponding devices described herein. In some examples, the UE 115-a, the UE 115-b, the base station 105-a, or a combination thereof may support half-duplex communications or full-duplex communications or both. While shown using the UE 115-a, the UE 115-b, and the base station 105-a, the techniques described herein may be performed by additional devices capable of half-duplex communications.

In some cases, the base station 105-a and the UE 115-a may support concurrent transmission and reception as part of a full-duplex mode or full-duplex communications. The UE 115-a may operate in a full-duplex mode, where the UE 115-a may transmit on an uplink and receive on a downlink simultaneously (e.g., at least partially overlapping), either on the same frequency resource or on different frequency resources. For example, the base station 105-a and the UE 115-a may communicate on an uplink and on a downlink simultaneously via a communications link 205-a. In some cases, the UE 115-a may support FD-FDD communications where the UE 115-a may likewise transmit on an uplink and receive on a downlink simultaneously. In some cases, for FD-FDD communications, the UE 115-a may participate in a RACH procedure during a RACH occasion if the RACH occasion overlaps with downlink reference signals (e.g., SSBs) and common downlink resources (e.g., due to the full-duplex capabilities of the UE 115-a).

In some cases, the base station 105-a and the UE 115-b may support half-duplex communications and, as such, may communicate over an uplink channel and over a downlink channel during non-overlapping time intervals. For example, the base station 105-a and the UE 115-b may support HD-FDD communications, where the UE 115-b may lack the ability to receive on a downlink and transmit on an uplink simultaneously. That is, the UE 115-b may receive on the downlink via a communications link 205-b and transmit on the uplink via a communications link 205-c.

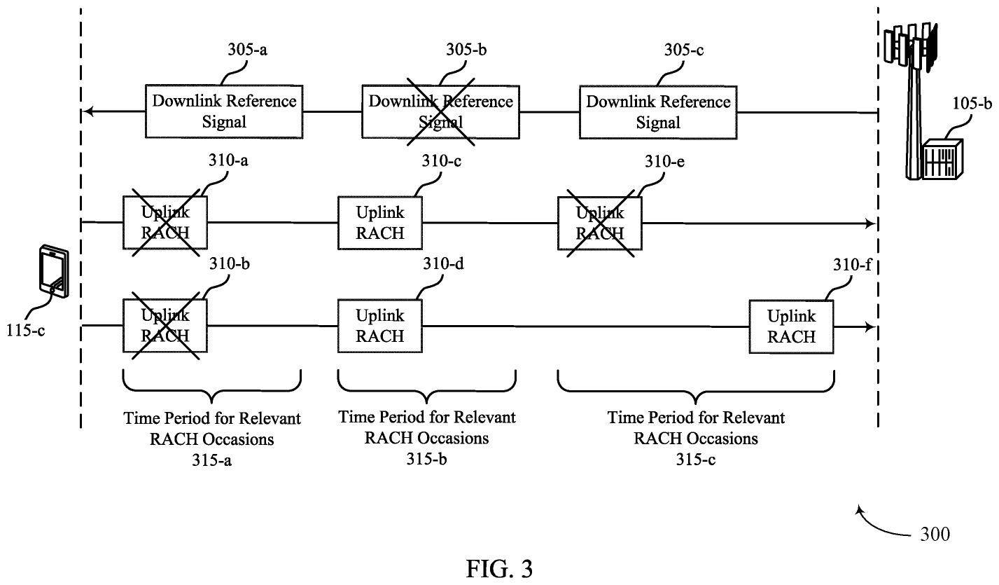

The wireless communications system 200 may implement techniques for improved RACH transmission and downlink reference signal monitoring by the UE 115-b. In some cases, the UE 115-b may monitor for one or more downlink reference signals 210 (e.g., SSBs) periodically transmitted from the base station 105-a on the communications link 205-b. The UE 115-b may determine that the UE 115-b is to participate in a RACH procedure with the base station 105-a during a RACH occasion. In some examples, the UE 115-b may identify that the downlink reference signal 210 (e.g., a downlink reference signal of the one or more downlink reference signals) is scheduled during a time period that includes the RACH occasion. That is, the UE 115-b may identify an overlap between the downlink reference signal 210 and the RACH occasion, which is described herein with reference to FIG. 3. Based on identifying that the downlink reference signal 210 is scheduled during the time period, the UE 115-b may refrain from monitoring for (e.g., may suspend the reception of) the downlink reference signal 210 during the time period in favor of proceeding with the RACH procedure 215. In some examples, the UE 115-b may transmit, to the base station 105-a, an indication that the UE 115-b initiated the RACH procedure 215.

In some examples, the UE 115-b may refrain from monitoring for the downlink reference signal 210 when the UE 115-b begins the RACH procedure 215 and if the relevant RACH occasions used to perform the RACH procedure 215 remains within a quantity of symbols (e.g., X symbols) within the downlink reference signal 210. For example, the UE 115-b (e.g., an HD-FDD UE) may be unable to monitor for the downlink reference signal 210 after a higher layer may initiate the UE 115-b to transmit RACH. In some examples, the downlink reference signal 210 may be an SSB, a CSI-RS, a tracking reference signal (TRS), a phase TRS, or a demodulation reference signal (DMRS). In some cases, in monitoring for the downlink reference signal 210, the UE 115-b may be configured to monitor for one or more combinations of RLM, BFD, L1-RSRP monitoring, L1-SINR monitoring, CLI monitoring, cell-level SS-RSRP monitoring, cell-level SS-RSRQ monitoring, or cell-level SS-SINR monitoring.

In some examples, the X symbols may depend on a switching gap used by the UE 115-b, and the switching gap may be a capability of the UE 115-b. For example, a Type A (e.g., dual phase locked loop) UE may use a higher switching gap, while a Type B (e.g., single phase locked loop) UE (e.g., an HD-FDD UE) may use a lower switching gap. The switching gap may be used for a transition between receiving on the downlink via the communications link 205-b and transmitting on the uplink via the communications link 205-c. As such, the UE 115-b may identify that the downlink reference signal 210 may be scheduled during a time period that includes the RACH occasion and a switching gap before and after the RACH occasion. For example, the switching gap may be two symbols, and a gap between a valid RACH occasion and an SSB (e.g., the downlink reference signal 210) may be one symbol. The UE 115-b may initiate the RACH procedure 215 (e.g., to transmit RACH) using the valid RACH occasion, however the UE 115-b may be unable to monitor for the SSB properly during the RACH transmission because the gap between the RACH occasion and the SSB may be shorter than the switching gap of the UE 115-b. Thus, the UE 115-b may skip monitoring of that SSB in favor of the RACH transmission. For example, the UE 115-b may refrain from monitoring for the downlink reference signal 210 during the time period based on the capability of the UE 115-b that may indicate a size of the switching gap before and after the RACH occasion, and where the size of the switching gap may depend on whether the UE 115-b is a single phase locked loop UE or a dual phase locked loop UE.

Some procedures, such as an RLM procedure or a BFD procedure, may depend on the length of the switching gap. That is, the UE 115-b may delay an RLM procedure or a BFD procedure based on refraining from receiving the downlink reference signal 210 during the time period. In some cases, the UE 115-b may send old L1 or L3 reports to the base station 105-a as the UE 115-b may be unable to make updated measurements (e.g., when the UE 115-b suspends monitoring of the downlink reference signal 210). In some cases, the UE 115-b may receive downlink signals except those that may be used during a RACH procedure 215 (e.g., Msg2, Msg4, or MsgB, where Msg2 PDSCH may be configured with type 1 PDCCH). In some examples, suspending reception on the downlink means that the UE 115-b may stop monitoring a serving cell of the UE 115-b, a neighboring cell of the UE 115-b, or both for UE-specific control signals. Additionally, the UE 115-b may continue to refrain from monitoring for the downlink reference signal 210 until the UE 115-b may complete the RACH procedure 215. That is, instead of the UE 115-b checking for an overlap between the downlink reference signal 210 and the RACH procedure 215, the UE 115-b may, by default, automatically ensure that the UE 115-b may refrain from monitoring or receiving any downlink during the RACH procedure 215. In some cases, the UE 115-b may refrain from receiving the downlink reference signal 210 after the UE 115-b starts the RACH procedure 215 even if the RACH occasion used for the RACH procedure 215 may be non-overlapping with the corresponding downlink reference signal 210. In some examples, the RACH procedure 215 may include both 4-step and 2-step RACH transmissions.

During the RACH procedure 215, the base station 105-a may suspend transmission of non-relevant downlink signals, including the downlink reference signal 210. For example, the base station 105-a may determine that the UE 115-b is participating in the RACH procedure 215 during the RACH occasion, and the base station 105-a may refrain from transmitting the downlink reference signal 210 during the RACH occasion based on determining that the UE 115-b is participating in the RACH procedure 215. For a RACH initiated by the base station 105-a (e.g., PDCCH order), the base station 105-a may suspend the downlink reference signal transmissions on its own. In some cases, for a RACH initiated by the UE 115-b (e.g., to request uplink resources), the UE 115-b may inform the base station 105-a (e.g., through Msg1, Msg3, MsgA) of the RACH procedure, which may prompt the base station to suspend non-relevant downlink transmissions (e.g., downlink reference signal transmissions) during the RACH procedure).

FIG. 3 illustrates an example of a timeline 300 that supports RACH transmission and downlink monitoring by a half-duplex UE in accordance with aspects of the present disclosure. In some examples, the timeline 300 may implement aspects of the wireless communications systems 100 and 200 or may be implemented by aspects of the wireless communications systems 100 and 200. In some cases, a base station 105-b and a UE 115-c may communicate downlink reference signals 305 and RACH 310 during time periods for relevant RACH occasions 315.

As described with reference to FIG. 2, some wireless communications systems may implement techniques for improved RACH transmission and downlink reference signal monitoring by the UE 115-c, which may operate in a half-duplex communications mode. In some cases, the UE 115-c may monitor for one or more downlink reference signals 305 (e.g., SSBs) periodically transmitted from the base station 105-b. The UE 115-c may determine that the UE 115-c is to participate in a RACH procedure with the base station 105-b during a RACH occasion, which may be included in a time period for relevant RACH occasions 315. In some cases, the UE 115-c may identify that a downlink reference signal 305 is scheduled during a time periods for relevant RACH occasions 315 that that includes a RACH occasion. That is, the UE 115-c may identify that a downlink reference signal 305 and a RACH 310 overlap in the same time period Based on identifying the overlap, the UE 115-c may refrain from monitoring for (e.g., may suspend the reception of) the downlink reference signals 305 during the time period for relevant RACH occasions 315 in favor of proceeding with the RACH 310.

In some examples, the UE 115-c may refrain from monitoring for the downlink reference signals 305 transmitted from the base station 105-b when the UE 115-c begins a RACH procedure (e.g., when the UE 115-c transmits a RACH 310) and if the RACH occasions used to transmit a RACH 310 remain within a quantity of symbols (e.g., X symbols) from the downlink reference signal 305. In some examples, if a subset of relevant RACH occasions overlap with the resources used for transmission of the downlink reference signals 305 (e.g., SSB locations) and a different subset of relevant RACH occasions are non-overlapping with the resources, the UE 115-c may select a RACH occasion judiciously such that the UE 115-c may monitor for the downlink reference signals 305 and transmit the RACH 310 simultaneously.

In some examples, the UE 115-c may select the RACH occasion based on the resources used for transmission of the downlink reference signals 305 (e.g., an SSB location), the location of the relevant RACH occasions, a switching gap between the downlink reference signals 305 and the RACH occasions, or any combination thereof. For example, the UE 115-c may identify that a downlink reference signal 305 is scheduled during a time period for relevant RACH occasions 315, which may include at least one relevant RACH occasion of multiple relevant RACH occasions. In some cases, the at least one RACH occasion may correspond with a reference signal for which the UE 115-c may be configured to monitor. The UE 115-c may continue to monitor for the downlink reference signal 305 transmitted from the base station 105-b during the time period for relevant RACH occasions 315 based on the at least one RACH occasion. The UE 115-c may then transmit RACH 310 for the RACH procedure outside of the time period for relevant RACH occasions 315. That is, the UE 115-c may monitor for the downlink reference signal 305 in a RACH occasion in the time period for relevant RACH occasions 315 that may overlap with the downlink reference signal 305, and the UE 115-c may proceed with the RACH procedure in a different RACH occasion in the time period for relevant RACH occasions 315 that may be non-overlapping with the downlink reference signal 305. In some cases, the relevant RACH occasions may include a list of RACH occasions that correspond to a set of reference signals (e.g., SSBs) scheduled for the UE 115-c (e.g., allowed or preferred by the UE 115-c). In some examples, the periodicity and offset of a RACH 310 may be different from the periodicity and offset of a downlink reference signal 305, and as such, for some set of downlink reference signals 305, a RACH occasion may overlap with a downlink reference signal 305 but may be non-overlapping with a downlink reference signal 305 in the next cycle.

In some cases, the UE 115-c may monitor for a downlink reference signal 305-a in a time period for relevant RACH occasions 315-a, which may include two or more relevant RACH occasions. Before initiating a RACH 310-a, the UE 115-c may determine that all relevant RACH occasions in the time period for relevant RACH occasions 315-a overlap with the downlink reference signal 305-a. That is, the UE 115-c may determine that the downlink reference signal 305-a overlaps with the whole time period for relevant RACH occasions 315-a. Based on the overlap, the UE 115-c may prioritize the monitoring and reception of the downlink reference signal 305-a, and the UE 115-c may refrain from initiating and transmitting the RACH 310-a or a RACH 310-b during the time period for relevant RACH occasions 315-a.

In some cases, if relevant RACH occasions) overlap with a downlink reference signal 305 (e.g., the SSB location) or are within a minimum switching gap the UE 115-c may use, the UE 115-c may determine to suspend reception of the downlink reference signal 305 in favor of transmitting a RACH 310. For example, the UE 115-c may monitor for a downlink reference signal 305-b in a time period for relevant RACH occasions 315-b, which may include two or more relevant RACH occasions. In some cases, the UE 115-c may initiate a RACH 310-c and a RACH 310-d in the time period for relevant RACH occasions 315-b. The UE 115-c may determine that all relevant RACH occasions within the time period for relevant RACH occasions 315-b overlap with the downlink reference signal 305-b. Based on the overlap, the UE 115-c may prioritize the transmission of a RACH 310-c and a RACH 310-d and the UE 115-c may refrain from monitoring for and receiving the downlink reference signal 305-b during the time period for relevant RACH occasions 315-b.

In some examples, the UE 115-c may monitor for a downlink reference signal 305-c in a time period for relevant RACH occasions 315-c, which may include two or more relevant RACH occasions. The UE 115-c may initiate a RACH procedure, which may include initiating the transmission of a RACH 310-e and a RACH 310-f. The UE 115-c may determine that one relevant RACH occasion in the time period for relevant RACH occasions 315-c overlaps with the downlink reference signal 305-c, while a different relevant RACH occasion in the time period for relevant RACH occasions 315-c may be non-overlapping with the downlink reference signal 305-c. That is, the UE 115-c may determine that a first relevant RACH occasion that includes the RACH 310-e may overlap with the downlink reference signal 305-c and that a second relevant RACH occasion that includes the RACH 310-f is non-overlapping with the downlink reference signal 305-c. As such, the UE 115-c may continue to monitor for the downlink reference signal 305-c and refrain from transmitting the RACH 310-e in the first relevant RACH occasion in the time period for relevant RACH occasions 315-c, and the UE 115-c may transmit the RACH 310-f and refrain from monitoring for or receiving the downlink reference signal 305-c in the second relevant RACH occasion in the time period for relevant RACH occasions 315-c.

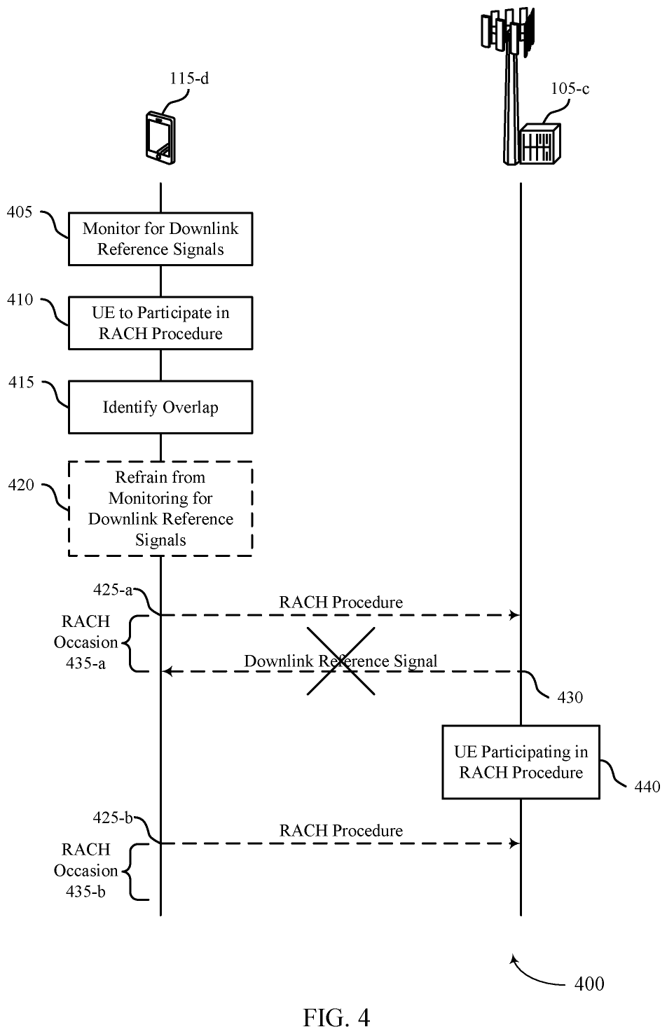

FIG. 4 illustrates an example of a process flow 400 that supports RACH transmission and downlink monitoring by a half-duplex UE in accordance with aspects of the present disclosure. The process flow 400 may implement aspects of wireless communications systems 100 and 200, or may be implemented by aspects of the wireless communications system 100 and 200. For example, the process flow 400 may illustrate operations between a UE 115-d and a base station 105-c, which may be examples of corresponding devices described herein. In the following description of the process flow 400, the operations between the UE 115-d and the base station 105-c may be transmitted in a different order than the example order shown, or the operations performed by the UE 115-d and the base station 105-c may be performed in different orders or at different times. Some operations may also be omitted from the process flow 400, and other operations may be added to the process flow 400.

At 405, the UE 115-d may monitor for one or more downlink reference signals (e.g., SSBs) periodically transmitted from the base station 105-c in a first time period. The UE 115-d may operate in a half-duplex communications mode such that the UE 115-d may receive downlink and transmit uplink on different resources. At 410, the UE 115-d may determine that the UE 115-d is to participate in a RACH procedure with the base station 105-c during the RACH occasion while operating in the half-duplex communications mode.

At 415, the UE 115-d may identify that a first downlink reference signal of the one or more downlink reference signals is scheduled during a second time period that includes at least one RACH occasion that corresponds with a reference signal for which the UE 115-d is configured to monitor, where the second time period is a subset of the first time period. That is, the UE 115-d may identify that the first downlink reference signal and the RACH are overlapping in a RACH occasion (e.g., the at least one RACH occasion). In some cases, the second time period may include the RACH occasion and a switching gap before and after the RACH occasion.

the base station 105-c may determine that the UE 115-d is participating in the RACH procedure with the base station 105-c during the RACH occasion, the UE 115-d operating in the half-duplex communications mode. For example, at 420, the UE 115-d may initiate the RACH procedure and may transmit RACH to the base station. At 425, the base station 105-c may schedule a first downlink reference signal (e.g., an SSB), where the RACH and the first downlink reference signal may both be in a time period that includes a RACH occasion 430.

At 420, the UE 115-d may refrain from monitoring for the first downlink reference signal during at least the second time period in favor of proceeding with the RACH procedure based on the identifying. For example, the UE 115-d may determine to participate in a RACH procedure 425-a, and the UE 115-d may identify that a downlink reference signal 430 is scheduled during the second time period, which includes a RACH occasion 435-a. As such, the UE 115-d may refrain from monitoring for the downlink reference signal 430 in favor or proceeding with the RACH procedure 425-a. In some cases, the UE 115-d may continue to monitor for the one or more downlink reference signals periodically transmitted from the base station 105-c based on a completion of the RACH procedure. In some examples, the UE 115-d may identify that one or more other downlink reference signals of the one or more downlink reference signals have corresponding RACH occasions that are scheduled during the first time period but outside of the second time period. In some examples, the UE 115-d may select, for the RACH procedure, a second downlink reference signal of the one or more other downlink reference signals based on the RACH occasion corresponding to the second downlink reference signals being scheduled during the first time period but outside of the second time period. In some cases, the at least one RACH occasion may correspond to the selected second downlink reference signal.

At 440, the base station 105-c may determine that the UE 115-d is participating in a RACH procedure 425-b with the base station 105-c during the RACH occasion 435-b, the UE 115-d operating in the half-duplex communications mode. Based on determining that the UE 115-d is participating in the RACH procedure 425-b, the base station 105-c may refrain from transmitting one or more downlink reference signals during the RACH occasion 435-b.

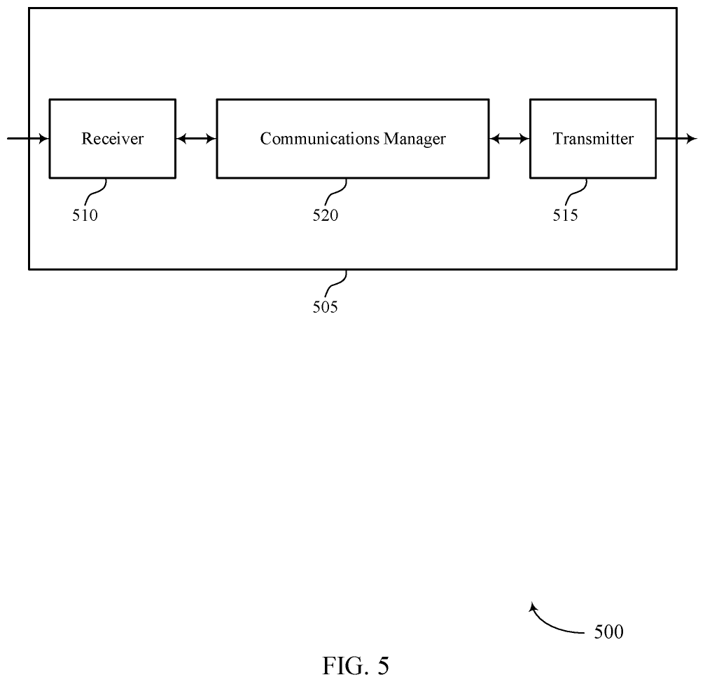

FIG. 5 shows a block diagram 500 of a device 505 that supports RACH transmission and downlink monitoring by a half-duplex UE in accordance with aspects of the present disclosure. The device 505 may be an example of aspects of a UE 115 as described herein. The device 505 may include a receiver 510, a transmitter 515, and a communications manager 520. The device 505 may also include at least one processor. Each of these components may be in communication with one another (e.g., via one or more buses).

The receiver 510 may provide a means for receiving information such as packets, user data, control information, or any combination thereof associated with various information channels (e.g., control channels, data channels, information channels related to RACH transmission and downlink monitoring by a half-duplex UE). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to RACH transmission and downlink monitoring by a half-duplex UE). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of RACH transmission and downlink monitoring by a half-duplex UE as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for monitoring for one or more downlink reference signals periodically transmitted from a base station during a first time period. The communications manager 520 may be configured as or otherwise support a means for determining that the UE is to participate in a RACH procedure with the base station during a RACH occasion while the UE is operating in a half-duplex communications mode. The communications manager 520 may be configured as or otherwise support a means for identifying that a first downlink reference signal of the one or more downlink reference signals is scheduled during a second time period that includes at least one RACH occasion that corresponds with a reference signal for which the UE is configured to monitor, where the second time period is a subset of the first time period. The communications manager 520 may be configured as or otherwise support a means for refraining from monitoring for the first downlink reference signal during at least the second time period in favor of proceeding with the RACH procedure based on the identifying.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for RACH transmission and downlink monitoring by a half-duplex UE, which may increase efficiency and reduce collisions between uplink and downlink communications. As such, supported techniques may include improved network operations, and, in some examples, may promote network efficiencies, among other benefits.

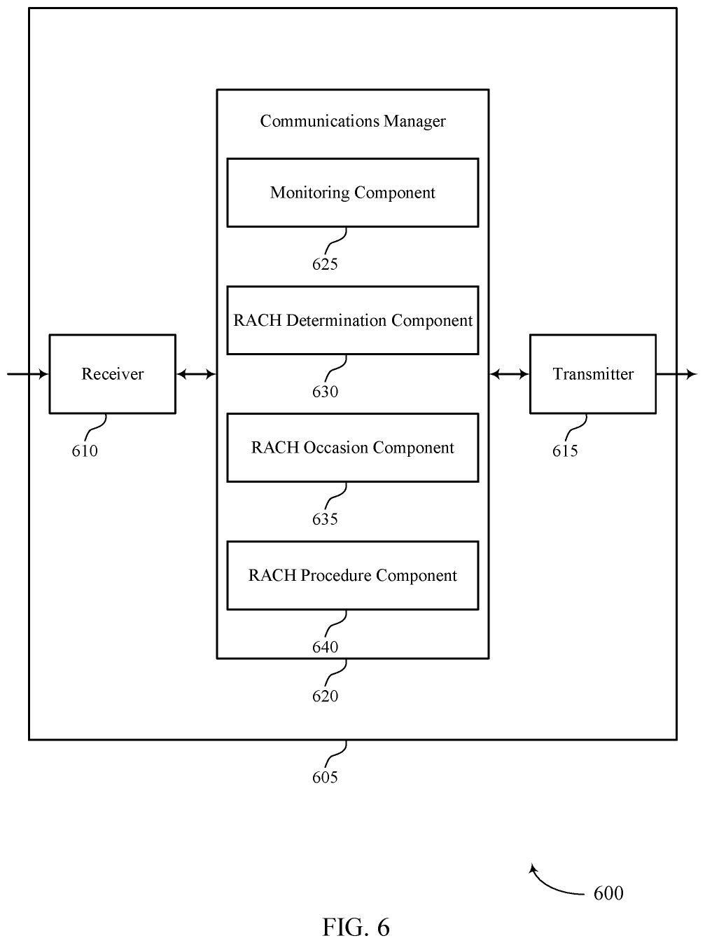

FIG. 6 shows a block diagram 600 of a device 605 that supports RACH transmission and downlink monitoring by a half-duplex UE in accordance with aspects of the present disclosure. The device 605 may be an example of aspects of a device 505 or a UE 115 as described herein. The device 605 may include a receiver 610, a transmitter 615, and a communications manager 620. The device 605 may also include at least one processor. Each of these components may be in communication with one another (e.g., via one or more buses).

The receiver 610 may provide a means for receiving information such as packets, user data, control information, or any combination thereof associated with various information channels (e.g., control channels, data channels, information channels related to RACH transmission and downlink monitoring by a half-duplex UE). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RACH transmission and downlink monitoring by a half-duplex UE). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of RACH transmission and downlink monitoring by a half-duplex UE as described herein. For example, the communications manager 620 may include a monitoring component 625, a RACH determination component 630, a RACH occasion component 635, a RACH procedure component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The monitoring component 625 may be configured as or otherwise support a means for monitoring for one or more downlink reference signals periodically transmitted from a base station during a first time period. The RACH determination component 630 may be configured as or otherwise support a means for determining that the UE is to participate in a RACH procedure with the base station during a RACH occasion while the UE is operating in a half-duplex communications mode. The RACH occasion component 635 may be configured as or otherwise support a means for identifying that a first downlink reference signal of the one or more downlink reference signals is scheduled during a second time period that includes at least one RACH occasion that corresponds with a reference signal for which the UE is configured to monitor, where the second time period is a subset of the first time period. The RACH procedure component 640 may be configured as or otherwise support a means for refraining from monitoring for the first downlink reference signal during at least the second time period in favor of proceeding with the RACH procedure based on the identifying.

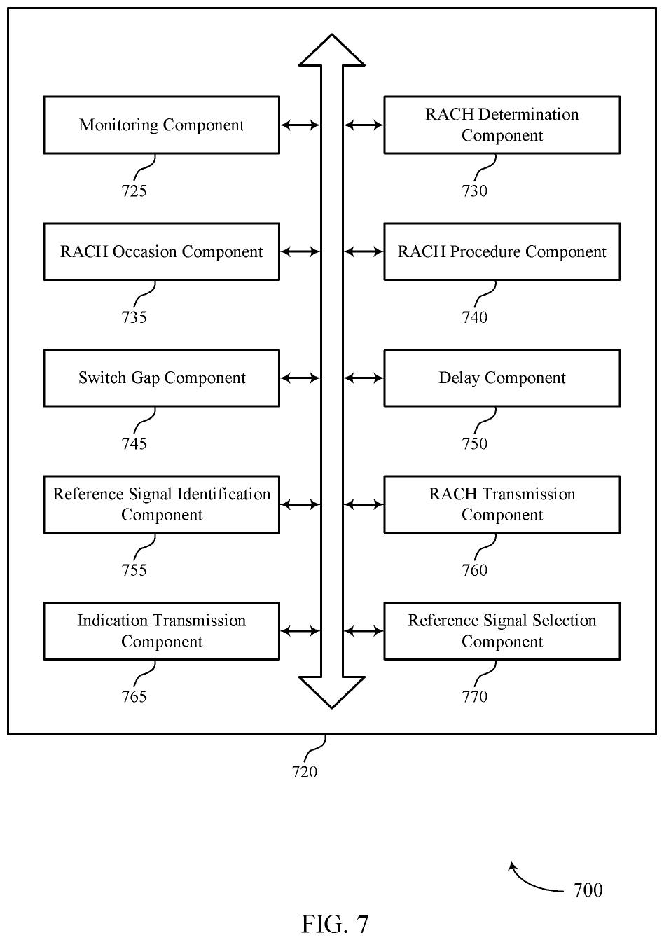

FIG. 7 shows a block diagram 700 of a communications manager 720 that supports RACH transmission and downlink monitoring by a half-duplex UE in accordance with aspects of the present disclosure. The communications manager 720 may be an example of aspects of a communications manager 520, a communications manager 620, or both, as described herein. The communications manager 720, or various components thereof, may be an example of means for performing various aspects of RACH transmission and downlink monitoring by a half-duplex UE as described herein. For example, the communications manager 720 may include a monitoring component 725, a RACH determination component 730, a RACH occasion component 735, a RACH procedure component 740, a switch gap component 745, a delay component 750, a reference signal identification component 755, a RACH transmission component 760, an indication transmission component 765, a reference signal selection component 770, or any combination thereof. Each of these components may communicate, directly or indirectly, with one another (e.g., via one or more buses).

The communications manager 720 may support wireless communications at a UE in accordance with examples as disclosed herein. The monitoring component 725 may be configured as or otherwise support a means for monitoring for one or more downlink reference signals periodically transmitted from a base station during a first time period. The RACH determination component 730 may be configured as or otherwise support a means for determining that the UE is to participate in a RACH procedure with the base station during a RACH occasion while the UE is operating in a half-duplex communications mode. The RACH occasion component 735 may be configured as or otherwise support a means for identifying that a first downlink reference signal of the one or more downlink reference signals is scheduled during a second time period that includes at least one RACH occasion that corresponds with a reference signal for which the UE is configured to monitor, where the second time period is a subset of the first time period. The RACH procedure component 740 may be configured as or otherwise support a means for refraining from monitoring for the first downlink reference signal during at least the second time period in favor of proceeding with the RACH procedure based on the identifying.

In some examples, to support refraining from monitoring for the first downlink reference signal, the switch gap component 745 may be configured as or otherwise support a means for refraining from monitoring for the first downlink reference signal during the second time period in favor of proceeding with the RACH procedure, where the second time period includes the at least one RACH occasion and a switch gap before and after the at least one RACH occasion.

In some examples, to support refraining from receiving the first downlink reference signal, the switch gap component 745 may be configured as or otherwise support a means for refraining from monitoring for the first downlink reference signal during the second time period based on a capability of the UE that indicates a size of the switch gap before and after the at least one RACH occasion.

In some examples, the size of the switch gap indicated as the capability of the UE depends on whether the UE is a dual phase locked loop UE or a single phase locked loop UE.

In some examples, the delay component 750 may be configured as or otherwise support a means for delaying an RLM procedure or a BFD procedure based on refraining from receiving the first downlink reference signal during the second time period.

In some examples, to support refraining from monitoring for the first downlink reference signal, the RACH procedure component 740 may be configured as or otherwise support a means for refraining from monitoring a serving cell of the UE, a neighboring cell of the UE, or both for one or more UE-specific control signals based on refraining from monitoring for the first downlink reference signal.

In some examples, the monitoring component 725 may be configured as or otherwise support a means for continuing to monitor for the first downlink reference signal periodically transmitted from the base station based on a completion of the RACH procedure.

In some examples, the RACH procedure component 740 may be configured as or otherwise support a means for refraining from monitoring for the first downlink reference signal during the first time period in favor of proceeding with the RACH procedure.

In some examples, the reference signal identification component 755 may be configured as or otherwise support a means for identifying that one or more other downlink reference signals of the one or more downlink reference signals have corresponding RACH occasions that are scheduled during the first time period but outside of the second time period. In some examples, the RACH transmission component 760 may be configured as or otherwise support a means for transmitting, for the RACH procedure, a RACH outside of the second time period based on the identifying.

In some examples, the reference signal selection component 770 may be configured as or otherwise support a means for selecting, for the RACH procedure, a second downlink reference signal of the one or more other downlink reference signals based on the RACH occasion corresponding to the second downlink reference signal being scheduled during the first time period but outside of the second time period.

In some examples, the at least one RACH occasion corresponds to the selected second downlink reference signal.

In some examples, the indication transmission component 765 may be configured as or otherwise support a means for transmitting, to the base station, an indication that the UE initiated the RACH procedure.

In some examples, to support monitoring for the one or more downlink reference signals, the monitoring component 725 may be configured as or otherwise support a means for configuring the monitoring for RLM, BFD, channel condition monitoring, CLI, or a combination thereof.

In some examples, the one or more downlink reference signals include an SSB, a CSI-RS, a TRS, a phase TRS, or a DMRS.

In some examples, the RACH procedure includes four-step RACH transmissions and two-step RACH transmissions. In some examples, the half-duplex communications mode in which the UE is operating is a half-duplex frequency division duplex communications mode.

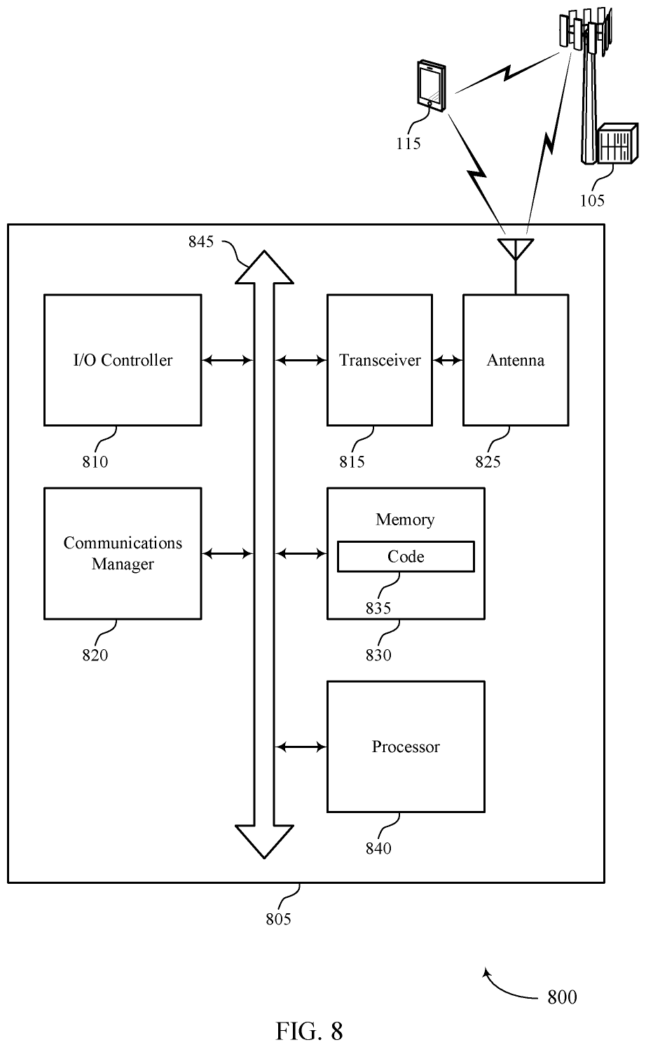

FIG. 8 shows a diagram of a system 800 including a device 805 that supports RACH transmission and downlink monitoring by a half-duplex UE in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting RACH transmission and downlink monitoring by a half-duplex UE). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for monitoring for one or more downlink reference signals periodically transmitted from a base station during a first time period. The communications manager 820 may be configured as or otherwise support a means for determining that the UE is to participate in a RACH procedure with the base station during a RACH occasion while the UE is operating in a half-duplex communications mode. The communications manager 820 may be configured as or otherwise support a means for identifying that a first downlink reference signal of the one or more downlink reference signals is scheduled during a second time period that includes at least one RACH occasion that corresponds with a reference signal for which the UE is configured to monitor, where the second time period is a subset of the first time period. The communications manager 820 may be configured as or otherwise support a means for refraining from monitoring for the first downlink reference signal during at least the second time period in favor of proceeding with the RACH procedure based on the identifying.

By including or configuring the communications manager 820 in accordance with examples as described herein, the device 805 may support techniques for RACH transmission and downlink monitoring by a half-duplex UE, which may increase efficiency and reduce collisions between uplink and downlink communications. As such, supported techniques may include improved network operations, and, in some examples, may promote network efficiencies, among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of RACH transmission and downlink monitoring by a half-duplex UE as described herein, or the processor 840 and the memory 830 may be otherwise configured to perform or support such operations.

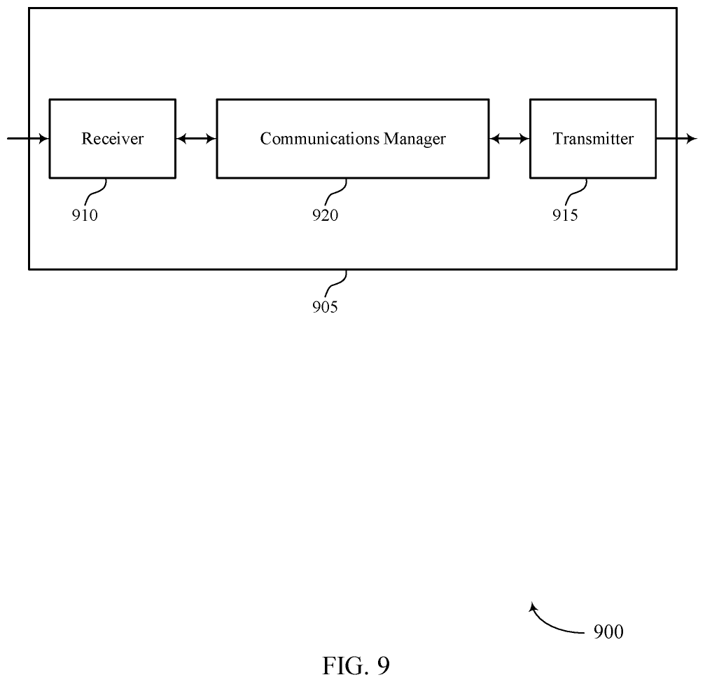

FIG. 9 shows a block diagram 900 of a device 905 that supports RACH transmission and downlink monitoring by a half-duplex UE in accordance with aspects of the present disclosure. The device 905 may be an example of aspects of a base station 105 as described herein. The device 905 may include a receiver 910, a transmitter 915, and a communications manager 920. The device 905 may also include at least one processor. Each of these components may be in communication with one another (e.g., via one or more buses).

The receiver 910 may provide a means for receiving information such as packets, user data, control information, or any combination thereof associated with various information channels (e.g., control channels, data channels, information channels related to RACH transmission and downlink monitoring by a half-duplex UE). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to RACH transmission and downlink monitoring by a half-duplex UE). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of RACH transmission and downlink monitoring by a half-duplex UE as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for determining that a UE is participating in a RACH procedure with the base station during a RACH occasion, the UE operating in a half-duplex communications mode. The communications manager 920 may be configured as or otherwise support a means for refraining from transmitting one or more downlink reference signals during the RACH occasion based on the determination.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for RACH transmission and downlink monitoring by a half-duplex UE, which may increase efficiency and reduce collisions between uplink and downlink communications. As such, supported techniques may include improved network operations, and, in some examples, may promote network efficiencies, among other benefits.

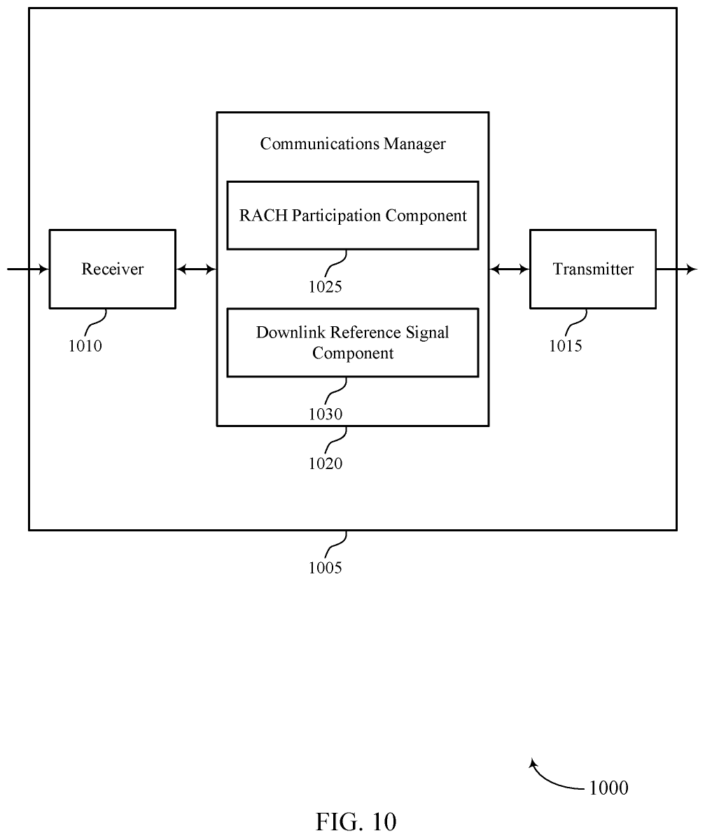

FIG. 10 shows a block diagram 1000 of a device 1005 that supports RACH transmission and downlink monitoring by a half-duplex UE in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include at least one processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to RACH transmission and downlink monitoring by a half-duplex UE). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to RACH transmission and downlink monitoring by a half-duplex UE). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of RACH transmission and downlink monitoring by a half-duplex UE as described herein. For example, the communications manager 1020 may include a RACH participation component 1025 a downlink reference signal component 1030, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The RACH participation component 1025 may be configured as or otherwise support a means for determining that a UE is participating in a RACH procedure with the base station during a RACH occasion, the UE operating in a half-duplex communications mode. The downlink reference signal component 1030 may be configured as or otherwise support a means for refraining from transmitting one or more downlink reference signals during the RACH occasion based on the determination.

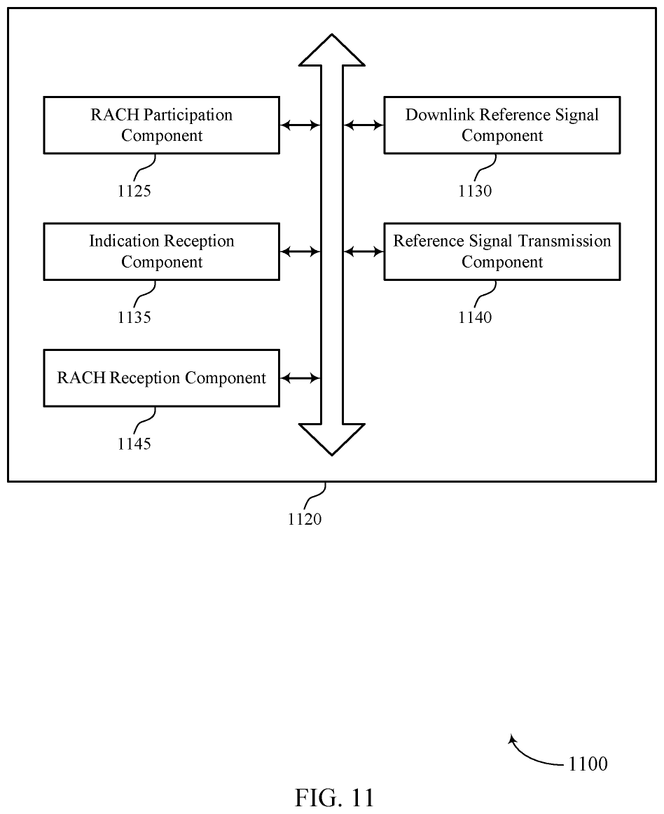

FIG. 11 shows a block diagram 1100 of a communications manager 1120 that supports RACH transmission and downlink monitoring by a half-duplex UE in accordance with aspects of the present disclosure. The communications manager 1120 may be an example of aspects of a communications manager 920, a communications manager 1020, or both, as described herein. The communications manager 1120, or various components thereof, may be an example of means for performing various aspects of RACH transmission and downlink monitoring by a half-duplex UE as described herein. For example, the communications manager 1120 may include a RACH participation component 1125, a downlink reference signal component 1130, an indication reception component 1135, a reference signal transmission component 1140, a RACH reception component 1145, or any combination thereof. Each of these components may communicate, directly or indirectly, with one another (e.g., via one or more buses).

The communications manager 1120 may support wireless communications at a base station in accordance with examples as disclosed herein. The RACH participation component 1125 may be configured as or otherwise support a means for determining that a UE is participating in a RACH procedure with the base station during a RACH occasion, the UE operating in a half-duplex communications mode. The downlink reference signal component 1130 may be configured as or otherwise support a means for refraining from transmitting one or more downlink reference signals during the RACH occasion based on the determination.

In some examples, the indication reception component 1135 may be configured as or otherwise support a means for receiving an indication that the UE initiated the RACH procedure. In some examples, the downlink reference signal component 1130 may be configured as or otherwise support a means for refraining from transmitting the one or more downlink reference signals during the RACH occasion based on receiving the indication.

In some examples, the reference signal transmission component 1140 may be configured as or otherwise support a means for continuing to transmit the one or more downlink reference signals periodically based on a completion of the RACH procedure.

In some examples, the reference signal transmission component 1140 may be configured as or otherwise support a means for continuing to transmit the one or more downlink reference signals periodically from the base station during a time period that includes at least one RACH occasion of a set of multiple RACH occasions. In some examples, the RACH reception component 1145 may be configured as or otherwise support a means for receiving a RACH outside of the time period.

In some examples, the one or more downlink reference signals include an SSB, a CSI-RS, a TRS, a phase TRS, or a DMRS.

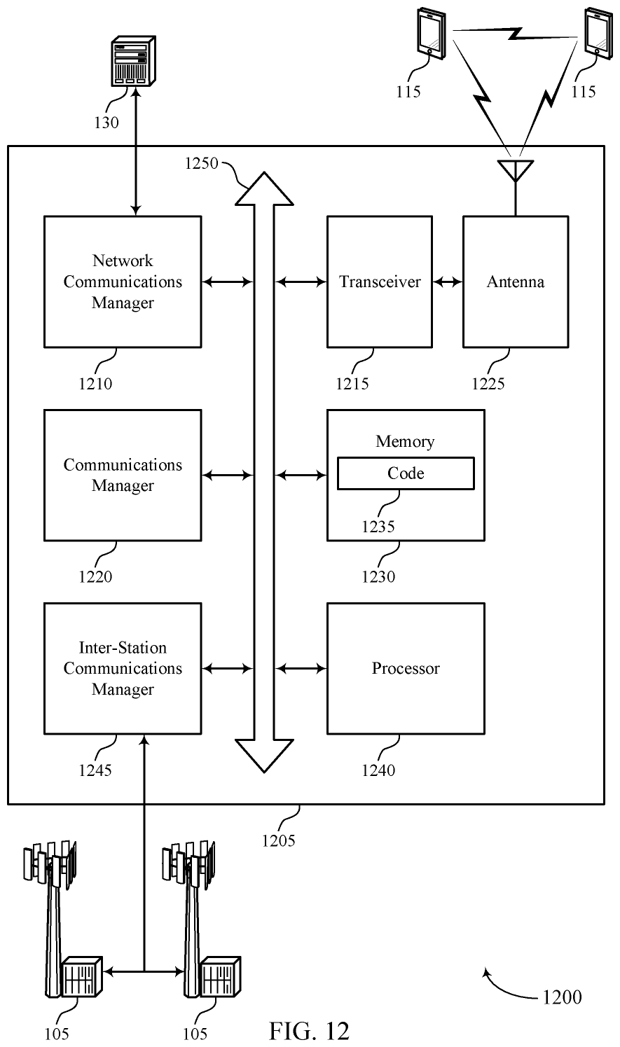

FIG. 12 shows a diagram of a system 1200 including a device 1205 that supports RACH transmission and downlink monitoring by a half-duplex UE in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, at least one processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting RACH transmission and downlink monitoring by a half-duplex UE). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for determining that a UE is participating in a RACH procedure with the base station during a RACH occasion, the UE operating in a half-duplex communications mode. The communications manager 1220 may be configured as or otherwise support a means for refraining from transmitting one or more downlink reference signals during the RACH occasion based on the determination.

By including or configuring the communications manager 1220 in accordance with examples as described herein, the device 1205 may support techniques for RACH transmission and downlink monitoring by a half-duplex UE, which may increase efficiency and reduce collisions between uplink and downlink communications. As such, supported techniques may include improved network operations, and, in some examples, may promote network efficiencies, among other benefits.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of RACH transmission and downlink monitoring by a half-duplex UE as described herein, or the processor 1240 and the memory 1230 may be otherwise configured to perform or support such operations.

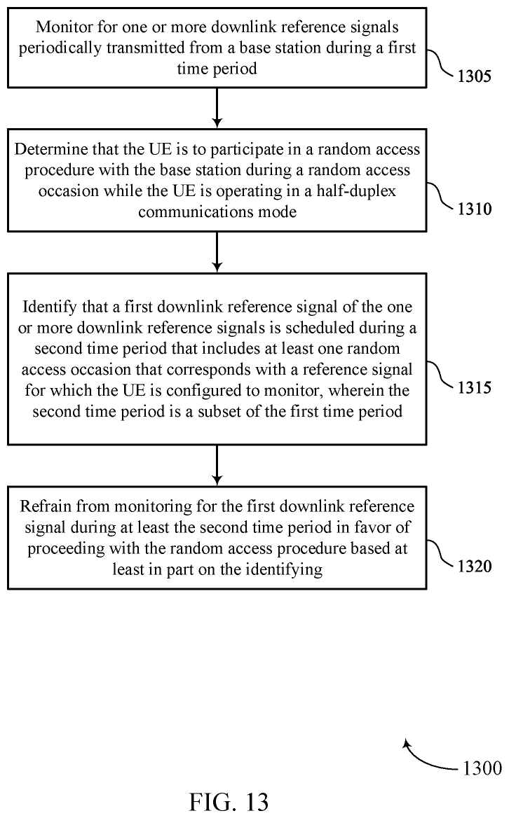

FIG. 13 shows a flowchart illustrating a method 1300 that supports RACH transmission and downlink monitoring by a half-duplex UE in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include monitoring for one or more downlink reference signals periodically transmitted from a base station during a first time period. The operations of 1305 may be performed in accordance with examples as disclosed herein. In some examples, aspects of the operations of 1305 may be performed by a monitoring component 725 as described with reference to FIG. 7.

At 1310, the method may include determining that the UE is to participate in a RACH procedure with the base station during a RACH occasion while the UE is operating in a half-duplex communications mode. The operations of 1310 may be performed in accordance with examples as disclosed herein. In some examples, aspects of the operations of 1310 may be performed by a RACH determination component 730 as described with reference to FIG. 7.

At 1315, the method may include identifying that a first downlink reference signal of the one or more downlink reference signals is scheduled during a second time period that includes at least one RACH occasion that corresponds with a reference signal for which the UE is configured to monitor, wherein the second time period is a subset of the first time period. The operations of 1315 may be performed in accordance with examples as disclosed herein. In some examples, aspects of the operations of 1315 may be performed by a RACH occasion component 735 as described with reference to FIG. 7.

At 1320, the method may include refraining from monitoring for the first downlink reference signal during at least the second time period in favor of proceeding with the RACH procedure based at least in part on the identifying. The operations of 1320 may be performed in accordance with examples as disclosed herein. In some examples, aspects of the operations of 1320 may be performed by a RACH procedure component 740 as described with reference to FIG. 7.

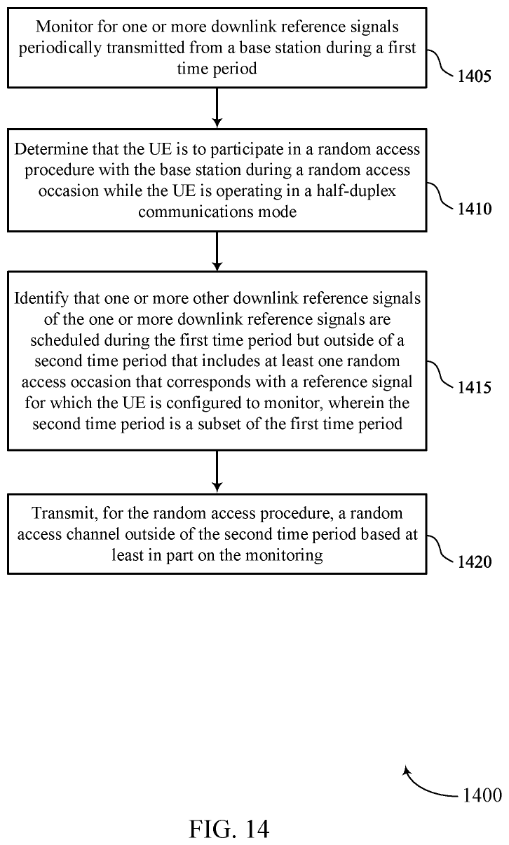

FIG. 14 shows a flowchart illustrating a method 1400 that supports RACH transmission and downlink monitoring by a half-duplex UE in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include monitoring for one or more downlink reference signals periodically transmitted from a base station during a first time period. The operations of 1405 may be performed in accordance with examples as disclosed herein. In some examples, aspects of the operations of 1405 may be performed by a monitoring component 725 as described with reference to FIG. 7.

At 1410, the method may include determining that the UE is to participate in a RACH procedure with the base station during a RACH occasion while the UE is operating in a half-duplex communications mode. The operations of 1410 may be performed in accordance with examples as disclosed herein. In some examples, aspects of the operations of 1410 may be performed by a RACH determination component 730 as described with reference to FIG. 7.

At 1415, the method may include identifying that one or more other downlink reference signals of the one or more downlink reference signals have corresponding RACH occasions that are scheduled during the first time period but outside of a second time period that includes at least one RACH occasion that corresponds with a reference signal for which the UE is configured to monitor, wherein the second time period is a subset of the first time period. The operations of 1415 may be performed in accordance with examples as disclosed herein. In some examples, aspects of the operations of 1415 may be performed by a reference signal identification component 755 as described with reference to FIG. 7.

At 1420, the method may include transmitting, for the RACH procedure, a RACH outside of the second time period based at least in part on the identifying. The operations of 1420 may be performed in accordance with examples as disclosed herein. In some examples, aspects of the operations of 1420 may be performed by a RACH transmission component 760 as described with reference to FIG. 7.

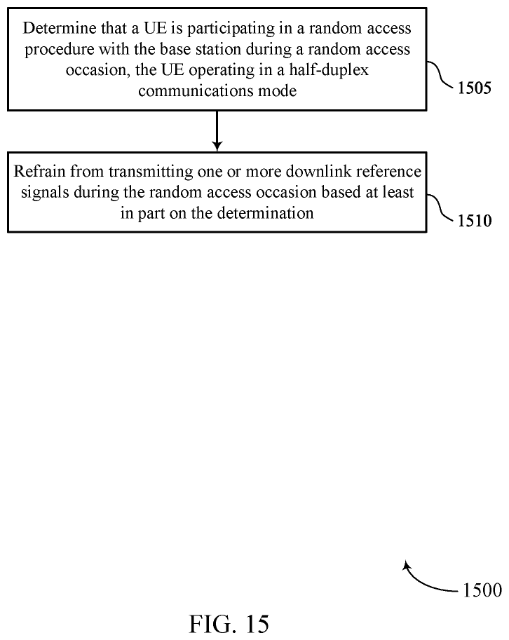

FIG. 15 shows a flowchart illustrating a method 1500 that supports RACH transmission and downlink monitoring by a half-duplex UE in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1505, the method may include determining that a UE is participating in a RACH procedure with the base station during a RACH occasion, the UE operating in a half-duplex communications mode. The operations of 1505 may be performed in accordance with examples as disclosed herein. In some examples, aspects of the operations of 1505 may be performed by a RACH participation component 1125 as described with reference to FIG. 11.

At 1510, the method may include refraining from transmitting one or more downlink reference signals during the RACH occasion based at least in part on the determination. The operations of 1510 may be performed in accordance with examples as disclosed herein. In some examples, aspects of the operations of 1510 may be performed by a downlink reference signal component 1130 as described with reference to FIG. 11.

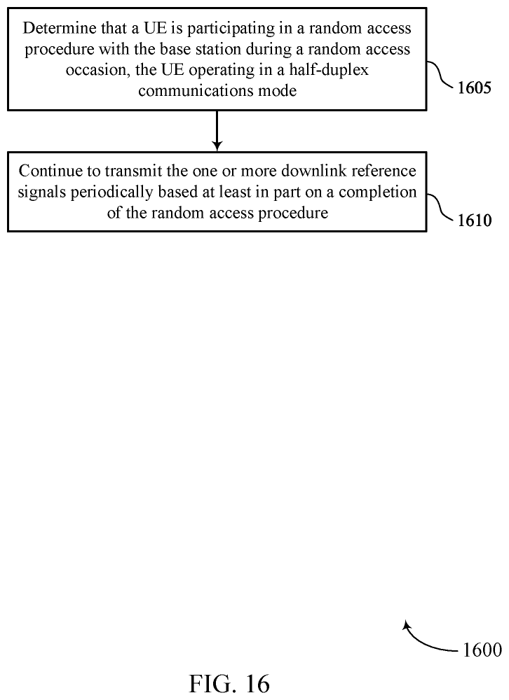

FIG. 16 shows a flowchart illustrating a method 1600 that supports RACH transmission and downlink monitoring by a half-duplex UE in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include determining that a UE is participating in a RACH procedure with the base station during a RACH occasion, the UE operating in a half-duplex communications mode. The operations of 1605 may be performed in accordance with examples as disclosed herein. In some examples, aspects of the operations of 1605 may be performed by a RACH participation component 1125 as described with reference to FIG. 11.

At 1610, the method may include continuing to transmit the one or more downlink reference signals periodically based at least in part on a completion of the RACH procedure. The operations of 1610 may be performed in accordance with examples as disclosed herein. In some examples, aspects of the operations of 1610 may be performed by a reference signal transmission component 1140 as described with reference to FIG. 11.

The following provides an overview of aspects of the present disclosure:

Aspect 1: A method for wireless communications at a UE, comprising: monitoring for one or more downlink reference signals periodically transmitted from a base station during a first time period: determining that the UE is to participate in a RACH procedure with the base station during a RACH occasion while the UE is operating in a half-duplex communications mode: identifying that a first downlink reference signal of the one or more downlink reference signals is scheduled during a second time period that includes at least one RACH occasion that corresponds with a reference signal for which the UE is configured to monitor, wherein the second time period is a subset of the first time period: and refraining from monitoring for the first downlink reference signal during at least the second time period in favor of proceeding with the RACH procedure based at least in part on the identifying.

Aspect 2: The method of aspect 1, wherein refraining from monitoring for the first downlink reference signal comprises: refraining from monitoring for the first downlink reference signal during the second time period in favor of proceeding with the RACH procedure, wherein the second time period comprises the at least one RACH occasion and a switch gap before and after the at least one RACH occasion.

Aspect 3: The method of aspect 2, wherein refraining from receiving the first downlink reference signal comprises: refraining from monitoring for the first downlink reference signal during the second time period based at least in part on a capability of the UE that indicates a size of the switch gap before and after the at least one RACH occasion.

Aspect 4: The method of aspect 3, wherein the size of the switch gap indicated as the capability of the UE depends on whether the UE is a dual phase locked loop UE or a single phase locked loop UE.

Aspect 5: The method of any of aspects 1 through 4, further comprising:

delaying an RLM procedure or a BFD procedure based at least in part on refraining from receiving the first downlink reference signal during the second time period.

Aspect 6: The method of any of aspects 1 through 5, wherein refraining from monitoring for the first downlink reference signal comprises: refraining from monitoring a serving cell of the UE, a neighboring cell of the UE, or both for one or more UE-specific control signals based at least in part on refraining from monitoring for the first downlink reference signal.

Aspect 7: The method of any of aspects 1 through 6, further comprising: continuing to monitor for the first downlink reference signal periodically transmitted from the base station based at least in part on a completion of the RACH procedure.

Aspect 8: The method of any of aspects 1 through 7, further comprising: refraining from monitoring for the first downlink reference signal during the first time period in favor of proceeding with the RACH procedure.

Aspect 9: The method of any of aspects 1 through 8, further comprising: identifying that one or more other downlink reference signals of the one or more downlink reference signals have corresponding RACH occasions that are scheduled during the first time period but outside of the second time period; transmitting, for the RACH procedure, a RACH outside of the second time period based at least in part on the identifying.

Aspect 10: The method of aspect 9, further comprising: selecting, for the RACH procedure, a second downlink reference signal of the one or more other downlink reference signals based at least in part on RACH occasion corresponding to the second downlink reference signal being scheduled during the first time period but outside of the second time period.

Aspect 11: The method of aspect 10, wherein the at least one RACH occasion corresponds to the selected second downlink reference signal.

Aspect 12: The method of any of aspects 1 through 11, further comprising: transmitting, to the base station, an indication that the UE initiated the RACH procedure.

Aspect 13: The method of any of aspects 1 through 12, wherein monitoring for the one or more downlink reference signals comprises: configuring the monitoring for RLM, BFD, channel condition monitoring, CLI, or a combination thereof.

Aspect 14: The method of any of aspects 1 through 13, wherein the one or more downlink reference signals comprise an SSB, a CSI-RS, a TRS, a phase TRS, or a DMRS.

Aspect 15: The method of any of aspects 1 through 14, wherein the RACH procedure comprises four-step RACH transmissions and two-step RACH transmissions.

Aspect 16: The method of any of aspects 1 through 15, wherein the half-duplex communications mode in which the UE is operating is a half-duplex frequency division duplex communications mode.

Aspect 17: A method for wireless communications at a base station, comprising: determining that a UE is participating in a RACH procedure with the base station during a RACH occasion, the UE operating in a half-duplex communications mode: and refraining from transmitting one or more downlink reference signals during the RACH occasion based at least in part on the determination.

Aspect 18: The method of aspect 17, further comprising: receiving an indication that the UE initiated the RACH procedure: and refraining from transmitting the one or more downlink reference signals during the RACH occasion based at least in part on receiving the indication.

Aspect 19: The method of any of aspects 17 through 18, further comprising: continuing to transmit the one or more downlink reference signals periodically based at least in part on a completion of the RACH procedure.

Aspect 20: The method of any of aspects 17 through 19, further comprising: continuing to transmit the one or more downlink reference signals periodically from the base station during a time period that includes at least one RACH occasion of a plurality of RACH occasions; and receiving a RACH outside of the time period.

Aspect 21: The method of any of aspects 17 through 20, wherein the one or more downlink reference signals comprise an SSB, a CSI-RS, a TRS, a phase TRS, or a DMRS.

Aspect 22: An apparatus for wireless communications at a UE, comprising at least one processor: memory coupled with the at least one processor; and instructions stored in the memory and executable by the at least one processor to cause the apparatus to perform a method of any of aspects 1 through 16.

Aspect 23: An apparatus for wireless communications at a UE, comprising at least one means for performing a method of any of aspects 1 through 16.

Aspect 24: A non-transitory computer-readable medium storing code for wireless communications at a UE, the code comprising instructions executable by at least one processor to perform a method of any of aspects 1 through 16.

Aspect 25: An apparatus for wireless communications at a base station, comprising at least one processor; memory coupled with the at least one processor; and instructions stored in the memory and executable by the at least one processor to cause the apparatus to perform a method of any of aspects 17 through 21.

Aspect 26: An apparatus for wireless communications at a base station, comprising at least one means for performing a method of any of aspects 17 through 21.

Aspect 27: A non-transitory computer-readable medium storing code for wireless communications at a base station, the code comprising instructions executable by at least one processor to perform a method of any of aspects 17 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein, including future systems and radio technologies.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone: B alone: C alone: A and B in combination: A and C in combination: B and C in combination; or A, B, and C in combination.

The term “determine” or “determining” encompasses a wide variety of actions and, therefore, “determining” can include calculating, computing, processing, deriving, investigating, looking up (such as via looking up in a table, a database or another data structure), or ascertaining, among other examples. Also, “determining” can include receiving (such as receiving information), accessing (such as accessing data in a memory) among other examples. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
monitoring for one or more downlink reference signals periodically transmitted from a base station during a first time period;
determining that the UE is to participate in a random access procedure with the base station during a random access occasion while the UE is operating in a half-duplex communications mode;
identifying that a first downlink reference signal of the one or more downlink reference signals is scheduled during a second time period that includes at least one random access occasion that corresponds with a reference signal for which the UE is configured to monitor, wherein the second time period is a subset of the first time period; and refraining from monitoring for the first downlink reference signal during at least the second time period in favor of proceeding with the random access procedure based at least in part on the identifying.

2. The method of claim 1, wherein refraining from monitoring for the first downlink reference signal comprises:
refraining from monitoring for the first downlink reference signal during the second time period in favor of proceeding with the random access procedure, wherein the second time period comprises the at least one random access occasion and a switch gap before and after the at least one random access occasion.

3. The method of claim 2, wherein refraining from receiving the first downlink reference signal comprises:
refraining from monitoring for the first downlink reference signal during the second time period based at least in part on a capability of the UE that indicates a size of the switch gap before and after the at least one random access occasion.

4. The method of claim 3, wherein the size of the switch gap indicated as the capability of the UE depends on whether the UE is a dual phase locked loop UE or a single phase locked loop UE.

5. The method of claim 1, further comprising:
delaying a radio link monitoring procedure or a beam failure detection procedure based at least in part on refraining from receiving the first downlink reference signal during the second time period.

6. The method of claim 1, wherein refraining from monitoring for the first downlink reference signal comprises:
refraining from monitoring a serving cell of the UE, a neighboring cell of the UE, or both for one or more UE-specific control signals based at least in part on refraining from monitoring for the first downlink reference signal.

7. The method of claim 1, further comprising:
continuing to monitor for the first downlink reference signal periodically transmitted from the base station based at least in part on a completion of the random access procedure.

8. The method of claim 1, further comprising:
refraining from monitoring for the first downlink reference signal during the first time period in favor of proceeding with the random access procedure.

9. The method of claim 1, further comprising:
identifying that one or more other downlink reference signals of the one or more downlink reference signals have corresponding random access occasions that are scheduled during the first time period but outside of the second time period;
transmitting, for the random access procedure, a random access channel outside of the second time period based at least in part on the identifying.

10. The method of claim 9, further comprising:
selecting, for the random access procedure, a second downlink reference signal of the one or more other downlink reference signals based at least in part on the random access occasion corresponding to the second downlink reference signal being scheduled during the first time period but outside of the second time period.

11. The method of claim 10, wherein the at least one random access occasion corresponds to the selected second downlink reference signal.

12. The method of claim 1, further comprising:
transmitting, to the base station, an indication that the UE initiated the random access procedure.

13. The method of claim 1, wherein monitoring for the one or more downlink reference signals comprises:
configuring the monitoring for radio link monitoring, beam failure detection, channel condition monitoring, cross link interference, or a combination thereof.

14. The method of claim 1, wherein the one or more downlink reference signals comprise a synchronization signal block, a channel state information reference signal, a tracking reference signal, a phase tracking reference signal, or a demodulation reference signal.

15. The method of claim 1, wherein the random access procedure comprises four-step random access transmissions and two-step random access transmissions.

16. The method of claim 1, wherein the half-duplex communications mode in which the UE is operating is a half-duplex frequency division duplex communications mode.

17. A method for wireless communications at a base station, comprising:
determining that a user equipment (UE) is participating in a random access procedure with the base station during a random access occasion, the UE operating in a half-duplex communications mode; and
refraining from transmitting one or more downlink reference signals during the random access occasion based at least in part on the determination.

18. The method of claim 17, further comprising:
receiving an indication that the UE initiated the random access procedure; and
refraining from transmitting the one or more downlink reference signals during the random access occasion based at least in part on receiving the indication.

19. The method of claim 17, further comprising:
continuing to transmit the one or more downlink reference signals periodically based at least in part on a completion of the random access procedure.

20. The method of claim 17, further comprising:
continuing to transmit the one or more downlink reference signals periodically from the base station during a time period that includes at least one random access occasion of a plurality of random access occasions; and
receiving a random access channel outside of the time period.

21. The method of claim 17, wherein the one or more downlink reference signals comprise a synchronization signal block, a channel state information reference signal, a tracking reference signal, a phase tracking reference signal, or a demodulation reference signal.

22. An apparatus for wireless communications at a user equipment (UE), comprising:
at least one processor;
memory coupled to the at least one processor; and
instructions stored in the memory and executable by the at least one processor to cause the apparatus to:
monitor for one or more downlink reference signals periodically transmitted from a base station during a first time period;
determine that the UE is to participate in a random access procedure with the base station during a random access occasion while the UE is operating in a half-duplex communications mode;
identify that a first downlink reference signal of the one or more downlink reference signals is scheduled during a second time period that includes at least one random access occasion that corresponds with a reference signal for which the UE is configured to monitor, wherein the second time period is a subset of the first time period; and
refrain from monitoring for the first downlink reference signal during at least the second time period in favor of proceeding with the random access procedure based at least in part on the identifying.

23. The apparatus of claim 22, wherein the instructions to refrain from monitoring for the first downlink reference signal are executable by the at least one processor to cause the apparatus to:
refrain from monitoring for the first downlink reference signal during the second time period in favor of proceeding with the random access procedure, wherein the second time period comprises the at least one random access occasion and a switch gap before and after the at least one random access occasion.

24. The apparatus of claim 23, wherein the instructions to refrain from receiving the first downlink reference signal are executable by the at least one processor to cause the apparatus to:
refrain from monitoring for the first downlink reference signal during the second time period based at least in part on a capability of the UE that indicates a size of the switch gap before and after the at least one random access occasion.

25. The apparatus of claim 24, wherein the size of the switch gap indicated as the capability of the UE depends on whether the UE is a dual phase locked loop UE or a single phase locked loop UE.

26. The apparatus of claim 22, wherein the instructions are further executable by the at least one processor to cause the apparatus to:
delay a radio link monitoring procedure or a beam failure detection procedure based at least in part on refraining from receiving the first downlink reference signal during the second time period.

27. The apparatus of claim 22, wherein the instructions to refrain from monitoring for the first downlink reference signal are executable by the at least one processor to cause the apparatus to:
refrain from monitoring a serving cell of the UE, a neighboring cell of the UE, or both for one or more UE-specific control signals based at least in part on refraining from monitoring for the first downlink reference signal.

28. An apparatus for wireless communications at a base station, comprising:
at least one processor;
memory coupled to the at least one processor; and
instructions stored in the memory and executable by the at least one processor to cause the apparatus to:
determine that a user equipment (UE) is participating in a random access procedure with the base station during a random access occasion, the UE operating in a half-duplex communications mode; and
refrain from transmitting one or more downlink reference signals during the random access occasion based at least in part on the determination.

29. The apparatus of claim 28, wherein the instructions are further executable by the at least one processor to cause the apparatus to:
receive an indication that the UE initiated the random access procedure; and
refrain from transmitting the one or more downlink reference signals during the random access occasion based at least in part on receiving the indication.

30. The apparatus of claim 28, wherein the instructions are further executable by the at least one processor to cause the apparatus to:
continue to transmit the one or more downlink reference signals periodically based at least in part on a completion of the random access procedure.
